(19) United States
(12) Patent Application Publication
(10) Pub. No.: US 2018/0079233 A1
(43) Pub. Date: Mar. 22, 2018

(54) METHODS FOR DETERMINING AN AMOUNT OF REMAINING PRINT MEDIA IN A PRINTER

(71) Applicant: Datamax-O'Neil Corporation, Orlando, FL (US)

(72) Inventors: Sébastien Michel Marie Joseph d'Armancourt, Singapore (SG); Thomas Celinder, Singapore (SG); Richard Hatle, Casselberry, FL (US)

(21) Appl. No.: 15/272,495

(22) Filed: Sep. 22, 2016

(51) Int. Cl. B41J 13/00

(52) U.S. Cl. CPC B41J 13/0009

(57) ABSTRACT

Printers and methods are provided for determining an amount of remaining print media in an operating printer. Waveform signal is received from encoder wheel having number (n) of sectors and proximate optical sensor. Waveform signal represents number of sectors (m) that, during measurement time (t), pass by optical sensor as encoder wheel rotates. If media encoder wheel, in response to receiving waveform signal, processor calculates length of remaining print media in media roll at instant time t2. If ribbon encoder wheel, in response to receiving waveform signal, processor at least one of calculates length of remaining ribbon in ribbon roll at instant time t2 or extrapolates the length of the remaining print media from a plurality of data points defining an interpolation equation.

### FIELD OF THE INVENTION

The present invention relates to printers and more particularly, to methods for determining an amount of remaining print media in a printer.

### BACKGROUND

There are many types of printers that use ink ribbon (or simply “ribbon”), including thermal transfer printers. The ink ribbons may be of various types, including different widths, lengths, thicknesses, ink colors, ribbon materials, and so forth. Typically, the ink ribbons are supplied on supply spools (also referred to herein as “ribbon cores” or simply “cores”) (that may be, for example, a cardboard tube). The ink ribbon supplies media (e.g., ink) that transfers onto print media (e.g., labels, paper, etc.). The ink ribbon continuously wound on the supply spool is collectively referred to herein as a “ribbon roll”. The print media wound on a supply spool (a “media core” or simply “core”) is collectively referred to herein as a “media roll”.

Some users of such printers would like advance warning that the ink ribbon in the ribbon roll and/or the print media in the media roll is near depletion and the printer will soon be unable to print. Conventional printers can detect and alert a user that the outer diameter of the ribbon roll and/or media roll has decreased below a specified minimum diameter threshold. Detecting that the ribbon and/or the print media on respective supply spools is near depletion is useful so that a replacement ribbon roll and/or media roll supply spool can be readied because the interruption of printing is inconvenient. However, the amount of remaining print media in the operating printer cannot be easily determined.

Therefore, a need exists for printers and methods for determining the amount of remaining print media in the operating printer (i.e., the amount of print media printable from the remaining ribbon/remaining print media on the supply spool used in the (operating) printer).

### SUMMARY

Accordingly, in one aspect, the present invention embraces a method for determining an amount of remaining print media in a printer, according to various embodiments. The method comprises receiving a waveform signal from a media encoder wheel having a number (n) of sectors and proximate an optical sensor. The waveform signal represents the number of sectors (m) that, during a measurement time (t), pass by the optical sensor as the media encoder wheel rotates. In response to receiving the waveform signal, the processor calculates a length of the remaining print media in a media roll at an instant time t2 (Media_{length2}).

A method is provided for determining an amount of remaining print media in a printer, according to various embodiments of the present invention. The method comprises receiving a waveform signal from a ribbon encoder wheel having a number (n) of sectors and proximate an optical sensor. The waveform signal represents the number of sectors (m) that, during a measurement time (t), pass by the optical sensor as the ribbon encoder wheel rotates. In response to receiving the waveform signal, the processor calculates a length of the remaining ribbon in a ribbon roll at the instant time t2 (Ribbon_{length2}). The length of the remaining ribbon at the instant time t2 comprises the length of the remaining print media at the instant time t2.

A method is provided for determining an amount of remaining print media in a printer, according to various embodiments of the present invention. The method comprises receiving a waveform signal from a ribbon encoder wheel having a number (n) of sectors and proximate an optical sensor. The waveform signal represents the number of sectors (m) that, during a measurement time (t), pass by the optical sensor as the ribbon encoder wheel rotates. In response to receiving the waveform signal, the processor extrapolates the length of the remaining print media from a plurality of data points defining an interpolation equation.

The foregoing illustrative summary, as well as other exemplary objectives and/or advantages of the present invention, and the manner in which the same are accomplished, are further explained within the following detailed description and its accompanying drawings.

### BRIEF DESCRIPTION OF THE DRAWINGS

FIG. 1 graphically illustrates a portion of an exemplary printer that may be used in a method for determining an amount of print media printable from remaining ribbon/remaining print media on a supply spool used in the printer according to various embodiments, a cover of the printer removed to illustrate ribbon and print media loading in the printer;

FIG. 2 schematically depicts components of the printer of FIG. 1 according to various embodiments, illustrating an exemplary ribbon path of the ink ribbon and a print media path of the print media used in the printer of FIG. 1;

FIG. 3 graphically illustrates a (full) ribbon roll comprising ribbon on a ribbon supply spool (also known as a “ribbon core” or simply a “core”) configured to be placed on a ribbon supply spindle of the printer such as depicted in FIG. 1 and an empty ribbon take configured to be placed on a ribbon rewind spindle of the printer;

FIG. 3A is a cross-sectional end view of the (full) ribbon roll of FIG. 3, identifying ribbon length (Ribbon_{length}), ribbon thickness (Th), ribbon roll outer diameter (d), and ribbon roll inner diameter (di), according to various embodiments;

FIG. 4 graphically illustrates a media roll comprising print media on a media supply spool (also known as a “media core” or simply “core”) used in the printer such as that depicted in FIG. 1 and FIG. 4A is a cross-sectional end view of the media roll, identifying media length (Media_{length}), media thickness (Th), media roll outer diameter (d), and media roll inner diameter (di), according to various embodiments;

FIG. 5 is a block diagram of a print control assembly of the printer such as that depicted in FIG. 1, according to various embodiments, including a ribbon encoder wheel (also depicted in FIG. 5A) and a media encoder wheel (also depicted in FIG. 5B);

FIG. 6 is a flow diagram of a method for determining an amount of print media (a determinative amount) printable from remaining ribbon on a ribbon supply spool used in a printer, according to various embodiments;

FIG. 7 is a flow diagram of a method for determining an amount of print media (a determinative amount) printable from remaining media on a print media supply spool used in a printer, according to various embodiments;

FIG. 8 is a flow diagram of a method for determining an amount of print media (an estimated amount) printable from remaining ribbon on a ribbon supply spool used in a printer, according to various embodiments; and

FIG. 8A is a table including exemplary calculated values for the outer diameter (d) of the ribbon roll at successive instant times and the media length used (Md_used) in successive time intervals, and the calculation of the estimated amount of the print media printable from the remaining ribbon on the ribbon supply spool used in a printer using an exemplary polynomial equation of a second order, according to various embodiments; and

FIGS. 8B and 8C are exemplary linear regression plots using the exemplary data points of FIG. 8A, illustrating the relationship between the outer diameter of the ribbon roll (d) and the media length used (Md_used) in accordance with various embodiments of the present invention (FIG. 8B) and the extrapolation of the length of the remaining print media from the plurality of data points (FIG. 8C), according to various embodiments of the present invention.

### DETAILED DESCRIPTION

Various embodiments are directed to printers and methods for accurately and efficiently determining an amount of print media that can be printed (i.e., printable) from remaining ribbon/remaining print media on a supply spool (also referred to herein as a “core”) used in an operating printer. Various embodiments provide the amount of print media printable from the remaining ribbon/remaining print media in a user-friendly way. The amount of print media printable from the remaining ribbon/remaining media on the supply spool may be a determinative amount or an estimated amount according to various embodiments. As hereinafter described, the “amount” of print media printable from remaining ribbon/remaining print media refers to a length of remaining print media (for continuous and non-continuous print media in a media roll as hereinafter described) or a quantity of non-continuous print media in the media roll as hereinafter described (e.g., individual labels (“label media”), etc.). The print media is non-continuous if there is a gap or mark between the individual labels, tickets, etc. in the media roll (e.g., die-cut media). As used herein, unless otherwise specified, the term “roll” refers to the ribbon roll and the media roll.

Various embodiments of the present invention will be described in relation to a thermal transfer printer. However, the present invention may be equally applicable to other types and styles of printers that may benefit from determining the amount of print media printable from remaining ribbon/remaining print media on a supply spool (referred to herein as a “core”) used in a printer. As used herein, the term “printer” refers to a device that prints text, barcodes, indicia, illustrations, etc. onto the print media (e.g., labels, tickets, plain paper, receipt paper, plastic transparencies, and the like). The ribbon supplies the media (e.g., ink) that transfers onto the print media and the ribbon may also be referred to herein as an “ink ribbon”. In various embodiments, an ink ribbon may not be used in the printer (e.g., a direct transfer printer).

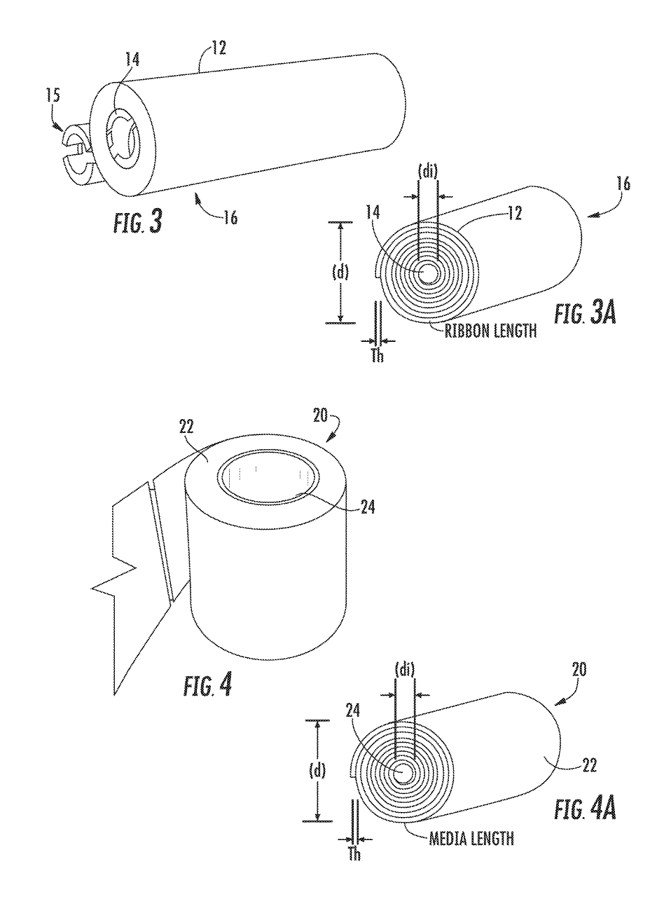

First referring briefly to FIGS. 3 and 3A, ribbon 12 is wound on a ribbon supply spool 14 (also known as a ribbon core or simply “core”), the ribbon 12 and ribbon supply spool 14 collectively referred to herein as a “ribbon roll” 16. An exemplary ribbon roll 16 and a ribbon supply spool (without ribbon) (i.e., a ribbon core) are depicted in FIG. 3. FIG. 3A is an end cross-section view of the ribbon roll 16. An ink surface on the ribbon may be wound outside or inside, i.e., the ribbon 12 has a winding type consisting of either an outer ink surface winding type or an inner ink surface winding type. The ribbon roll is configured to rotate in a forward or a backward rotational direction, depending on the winding type.

As shown in FIG. 3A, the ribbon 12 has a ribbon length (Ribbon_{Length}) and a ribbon thickness (Th) and the ribbon roll has an outer diameter (d) and an inner diameter (di). The outer diameter (d) of the ribbon roll decreases as the ribbon is used for printing. Therefore, the outer diameter at a time instant is expressed as d1 at instant t1, d2 at instant t2, and so forth. The ribbon roll inner diameter (di) is also known as a “ribbon core outer diameter” (i.e., the outer diameter (di) of the ribbon supply spool (i.e., the ribbon core) 14 as depicted in FIG. 3A). The ribbon core outer diameter (di) is set by the manufacturer but may deviate as hereinafter described. As previously noted, it is not necessary that a ribbon roll be used in the printer, according to various embodiments.

Referring now briefly to FIGS. 4 and 4A, a media roll 20 comprises print media 22 wound on a media supply spool 24 (also referred to herein as a “media core”), the print media and media supply spool 24 collectively referred to as the “media roll” 20. An exemplary media roll 20 is depicted in FIGS. 4 and 4A. As noted previously, the print media may be continuous or non-continuous. The length of the print media 22 may or may not correspond with the effective print area and may not be an exact multiple of the printed media size. As shown in FIG. 4A, the print media 22 has a media length (Media_{length}) and a media thickness (Th) and the media roll 20 has an outer diameter (d) and an inner diameter (di). The outer diameter (d) of the media roll decreases as the print media is used for printing. Therefore, the outer diameter of the media roll 20 at a time instant, like the outer diameter of the ribbon roll, is expressed as d1 at instant t1, d2 at instant t2, and so forth. The media roll inner diameter (di) is also known as a “media core outer diameter” (i.e., the outer diameter of the media supply spool 24 or media core as depicted in FIG. 4A). As noted previously, the print media 22 may comprise labels, tickets, plain paper, plastic transparencies, and the like.

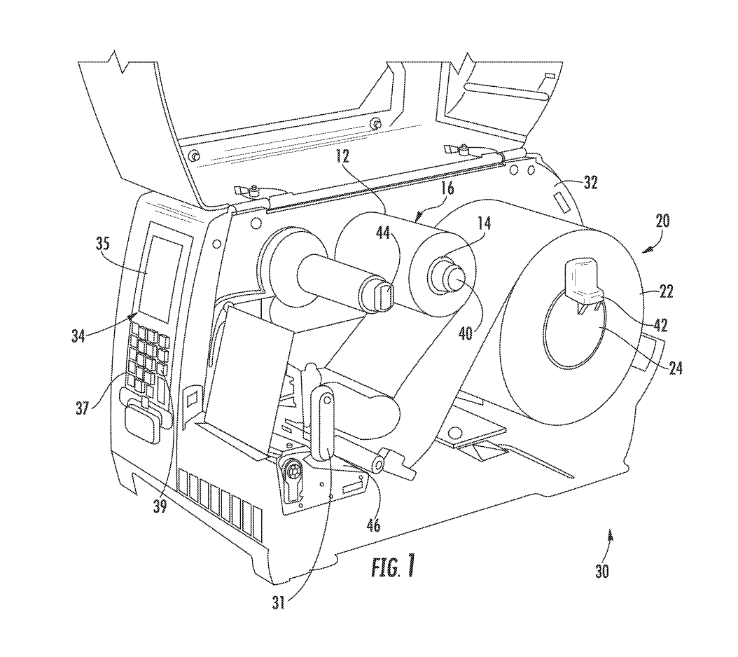

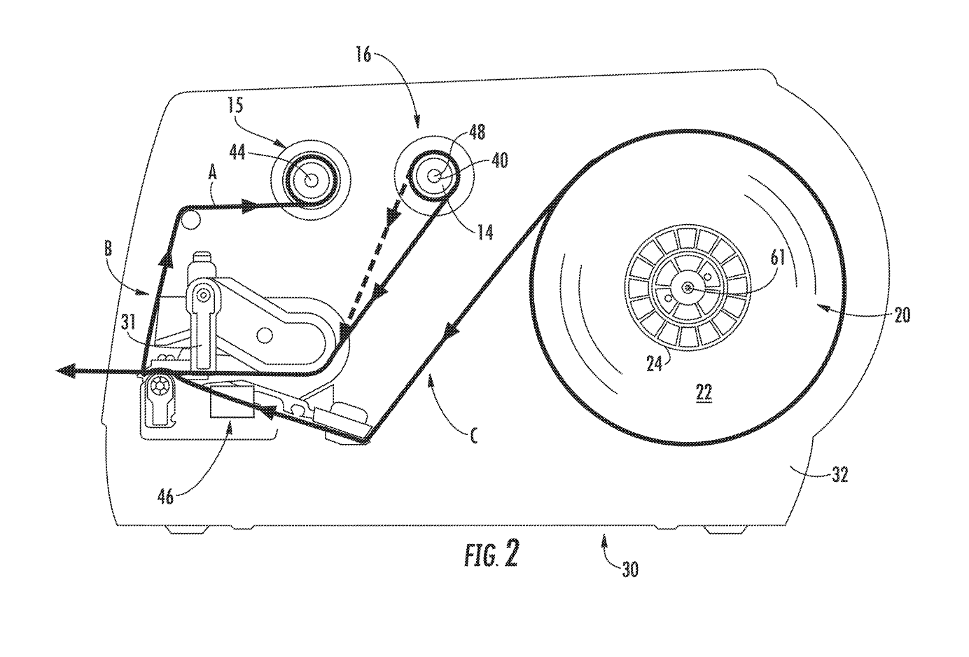

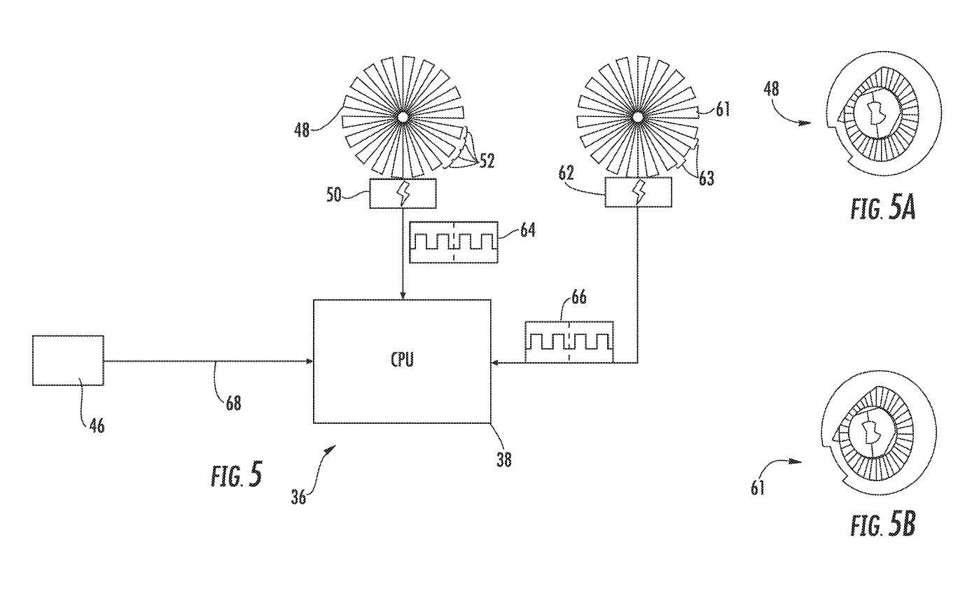

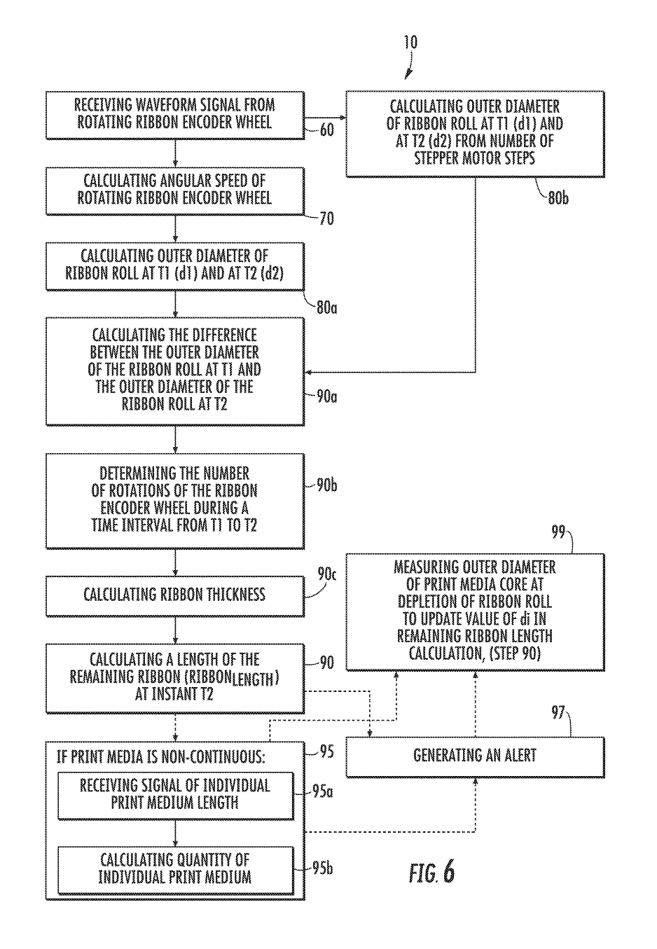

Now referring to FIGS. 1 and 2, according to various embodiments, an exemplary printer 30 capable of printing on print media 20 is partially shown. The depicted printer 30 has a body 32 including a user interface 34 (FIG. 1) for communication between a user and the printer 30 and a print control assembly 36 (FIGS. 1, 2, and 5) contained within the body 32. While the illustrated print control assembly 36 is contained within the body 32 of the printer 30, it is to be understood that the print control assembly 36 may be external of the printer. The printer 30 further comprises a power source and a moveable cover (removed in FIG. 1 for purposes of illustration) for accessing the print control assembly 36 (e.g., FIG. 5) contained within the body 32.

Still referring to FIGS. 1, 2, and now specifically to FIG. 5, according to various embodiments, the print control assembly 36 comprises a ribbon supply spindle 40 on which the ribbon roll 16 (FIGS. 3 and 3A) is configured to be disposed, a media supply spindle 42 on which the media roll 20 (FIGS. 4 and 4A) is configured to be disposed, and a ribbon rewind spindle 44 on which unwound ribbon (FIG. 3) is wound up. A ribbon roll leading edge is pulled forward (arrow A) above a stop sensor 46 of the print control assembly 36 and attached to the ribbon rewind spindle 44 (with, for example, tape on the empty ribbon take 15). The ribbon rewind spindle 44 is rotated until the ribbon overlaps the ribbon leading edge and stretches tight. The media roll is inserted onto the media supply spindle and threaded through the printer according to the printer manufacturer's instructions. An empty ribbon take 15 may be disposed on the ribbon rewind spindle 44 although the empty ribbon take 15 (e.g., empty ribbon take 15 on the left in FIG. 3) on the ribbon rewind spindle 44 may not be necessary.

Referring now specifically to FIG. 5, according to various embodiments, the print control assembly 36 further comprises a ribbon encoder wheel 48 proximate a first optical sensor and may additionally comprise a media encoder wheel 61 proximate a second optical sensor. Each of the ribbon encoder wheel and the media encoder wheel is communicatively coupled to a central processing unit (CPU) (herein, a “processor 38”) of the print control assembly 36. According to various embodiments, the printer 30 (more particularly, the print control assembly 36) may further comprise a stop sensor 46 (e.g., a label stop sensor). The stop sensor 46 is communicatively coupled to the processor (CPU) 38 as shown in FIG. 5. The stop sensor 46 outputs an analog signal 68 representing a print medium length (e.g., the length of an individual label) of the non-continuous media as hereinafter described.

Still referring to FIGS. 1, 2, and 5, and now to FIG. 5A, the ribbon supply spindle 40 in the print control assembly includes the ribbon encoder wheel 48 proximate the optical sensor 50. The optical sensor 50 proximate the ribbon encoder wheel 48 monitors the ribbon roll 16 (FIGS. 3 and 3A). The ribbon encoder wheel 48 rotates as the ribbon 12 unwinds from the ribbon roll 16 during printing. Referring now specifically to FIGS. 5 and 5A, the ribbon encoder wheel 48 may be a round flat plate with several equidistant ribbon encoder wheel sectors 52 dispersed radially about an axis of the ribbon encoder wheel 48. The plurality of sectors defines a series of circumferentially spaced markings. The number (n) of sectors in the ribbon encoder wheel 48 is used for determining an angular speed of the ribbon encoder wheel 48 as hereinafter described. The optical sensor 50 proximate the ribbon encoder wheel 48 detects and counts the sectors as the sectors pass the optical sensor during rotation of the ribbon encoder wheel. The number of sectors seen in “t” time, with “t” representing a time interval, is referred to as “m” in the equation for determining the angular speed of the ribbon encoder wheel as hereinafter described. While the ribbon encoder wheel 48 depicted in FIGS. 5 and 5A has 36 ribbon encoder wheel sectors, it is to be understood that the number (n) of ribbon encoder wheel sectors may be less than or greater than 36.

Still referring to FIGS. 1, 2, 5, and now to FIG. 5B, similar to the ribbon supply spindle 40, the media supply spindle 42 may include the media encoder wheel 61 and the optical sensor 62 communicatively coupled to the processor 38 (CPU) of the print control assembly 36. The optical sensor 62 is proximate the media encoder wheel 61. The optical sensor 62 proximate the media encoder wheel 61 monitors the media roll 20. Like the ribbon encoder wheel 48, the media encoder wheel 61 may be a round flat plate with several equidistant media encoder wheel sectors 63 dispersed radially about an axis of the media encoder wheel 61. The plurality of sectors defines a series of circumferentially spaced markings. The optical sensor 62 detects and counts the sectors as the sectors pass the optical sensor of the media encoder wheel 61, during rotation of the media encoder wheel 61. As with the ribbon encoder wheel 48, the number (n) of media encoder wheel sectors 63 and the number of sectors detected and counted in “t” is used to determine the angular speed of the media encoder wheel 61. While the media encoder wheel 61 depicted in FIGS. 2 and 5B has 36 media encoder wheel sectors 63, it is to be understood that the number of media encoder wheel sectors may be less than or greater than 36. The number of media encoder wheel sectors may be the second as or different from the number of ribbon encoder wheel sectors.

While a printer having both a ribbon encoder wheel 48 and a media encoder wheel 61 is described, it is to be understood that the printer may have only the ribbon encoder wheel (i.e., no media encoder wheel with proximate optical sensor), although more information regarding rotation speed and position is obtained if the printer has both the ribbon encoder wheel and the media encoder wheel, according to various embodiments. It is also to be understood that additional or alternative optical and/or electromagnetic interrupters such as holes, spokes, etc. may be used on the encoder wheel(s) to detect rotation speed and position (i.e., angular speed).

Each encoder wheel 48 and 61 is configured to rotate during operation of the printer and output an encoder wheel waveform signal as depicted in FIG. 5. The encoder wheels 48 and 61 may rotate at the same or different speeds. The ribbon encoder wheel 48 and the media encoder wheel 61 rotate as the ribbon 12 and print media 22 respectively unwind during printing, generating the encoder wheel waveform signal. The ribbon encoder wheel generates a ribbon encoder wheel waveform signal 64. As noted previously, the ribbon encoder wheel waveform signal 64 represents the number of ribbon encoder wheel sectors (n) of the rotating ribbon encoder wheel 48 that pass the proximate optical sensor 50 during a time interval from t1 to t2. The media encoder wheel 61 generates a media encoder wheel waveform signal 66 representing the number of media encoder wheel sectors (n) that pass the proximate optical sensor 62 of the media encoder wheel 61 during a time interval from t1 to t2. The encoder wheel waveform signal 64 and 66 is generally a square waveform signal (High/Low) as depicted.

As known in the art, the central processing unit (CPU) (i.e., the processor 38) is the electronic circuitry within a computer that carries out the instructions of a computer program by performing the basic arithmetic, logical, control and input/output (I/O) operations specified by the instructions as hereinafter described. According to various embodiments, the processor 38 is configured by a software program to perform the steps as hereinafter described.

The printer 30 may further comprise a thermal print head 31 utilized to thermally transfer a portion of ink from the ink ribbon 12 to the print media 22 as the ink ribbon is unwound from the ribbon supply spool 14 along a ribbon path (arrow B in FIG. 2) and the print media is unwound from the media supply spool 24 along a media path (arrow C in FIG. 2) and one or more motors (not shown) for rotating the ribbon supply spindle 40 and the ribbon roll 16 disposed thereon in a forward or a backward rotational direction (dependent on the ink surface), for rotating the media supply spindle 42 and the media roll 20 disposed thereon in a forward rotational direction, and for rotating the ribbon rewind spindle 44. In accordance with various embodiments, a stepper motor may be used for rotating the media supply spindle 42 and the media roll 20 disposed thereon in a forward rotational direction, for purposes as hereinafter described. A wind-up motor may be included in the printer 30 for rotating the ribbon rewind spindle 44 on which the unwound ink ribbon from the ribbon supply spindle 40 can be collected. The printer 30 may have other components, such as a print slot from which the printed media exits from the printer 30, and a cutting assembly for assisting in the cutting or separation of the printed media from non-continuous media. The printer 30 and print control assembly 36 may have other components as known in the art.

The user interface 34 (FIG. 1) may include, but is not limited to, a display 35 for displaying information, a keypad for entering data, and function buttons 39 that may be configured to perform various typical printing functions (e.g., cancel print job, advance print media, and the like) or be programmable for the execution of macros containing preset printing parameters for a particular type of print media. Additionally, the user interface 34 may be operationally/communicatively coupled to the processor (CPU) (not shown) for controlling the operation of the printer 30, in addition to other functions discussed below in greater detail. The user interface 34 may be supplemented by or replaced by other forms of data entry or printer control such as a separate data entry and control module linked wirelessly or by a data cable operationally coupled to a computer, a router, or the like.

According to various embodiments, the user interface 34 may display a printer consumption report. The printer consumption report may include, for example, a printer consumption alert that notifies the user about the length of remaining ribbon on the ribbon supply spool, the length of remaining print media on the media supply spool, and/or the amount (length or quantity) of print media printable from the same, etc.

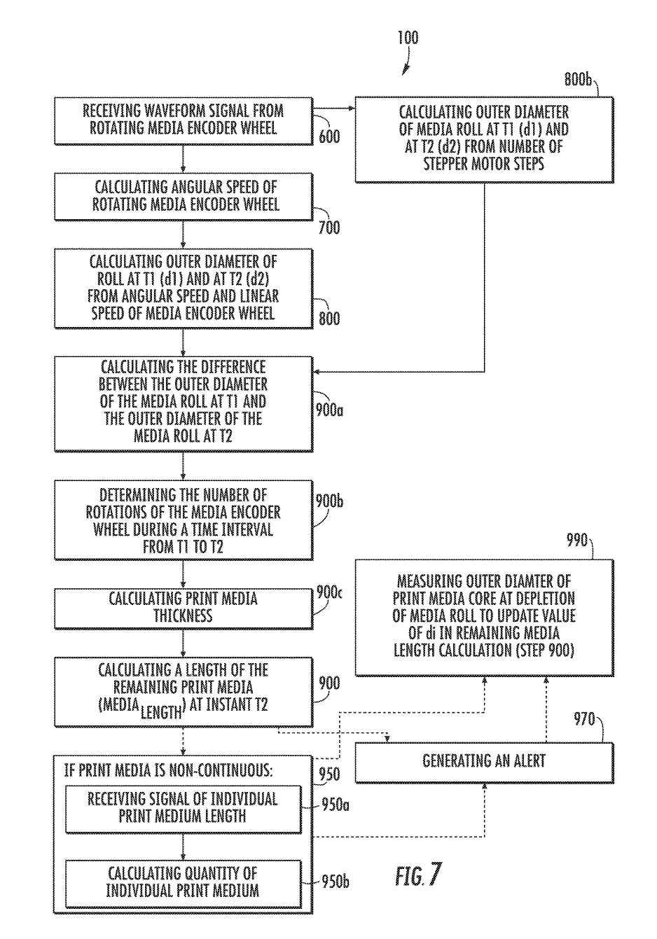

Referring now to FIG. 6, according to various embodiments, a method 10 for determining an amount of print media printable from remaining ribbon on a ribbon supply spool used in a printer is illustrated. The amount of print media printable from the remaining ribbon on the ribbon supply spool used in the printer is a determinative amount (as opposed to an estimated amount). The “remaining ribbon length” refers to the length of the remaining ribbon 12 in the ribbon roll 16 on the ribbon supply spool (i.e., ribbon core) 14 disposed on the ribbon supply spindle 40 of the printer 30, i.e., the ribbon available to transfer ink therefrom onto the remaining print media 22.

According to various embodiments, method 10 begins by receiving the ribbon encoder wheel waveform signal from the ribbon encoder wheel (step 60). More specifically, the processor (CPU) 38 is configured to receive the ribbon encoder wheel waveform signal 64 generated from the ribbon encoder wheel 48. As noted previously, the ribbon encoder wheel waveform signal 64 represents the number (n) of sectors of the ribbon encoder wheel that pass by the optical sensor 50 of the ribbon encoder wheel 48 during a specific time interval.

The processor (CPU) 38 is configured, from the ribbon encoder wheel waveform signal 64, to calculate the angular speed (ω in rad/s) of the ribbon encoder wheel 48 (step 70) using the following equation:

$$Angular speed ( ω ) = \frac{Angle traveled}{Time taken} = \frac{θ}{t}$$

$$ω ( \frac{rad}{s} ) = \frac{θ}{t} = \frac{2 π}{n} \times \frac{m}{t} \{ \begin{matrix} & n number of sectors in encoder wheel \\ with \text{:} & m number of sectors seen in “ t ” time \\ & t measurement time\end{matrix}$$

Still referring to FIG. 6, according to various embodiments, method 10 for determining the amount of print media printable from remaining ribbon on a ribbon supply spool used in a printer may continue by the processor (CPU) 38 calculating the outer diameter (d) of the ribbon roll 16 at an instant t1 and at an instant t2 using the angular speed calculated in step 70 and a linear speed (step 80a) using the following equation as known in the art:

$$Ribbon diameter \text{:} d ( mm ) = 2 ( 25.4 \frac{v}{ω} ) = 2 ( 25.4 \frac{v \cdot ( n \cdot t )}{2 π \cdot m} )$$

The linear speed (v in inches per second (ips)) is known from the print speed.

In various embodiments in which a stepper motor is used in the printer to rotate the media supply spindle and media roll disposed thereon, the outer diameter of the ribbon roll 16 may alternatively be calculated from a number of steps (i) of the stepper motor in a single rotation/revolution of the ribbon encoder wheel using the equation: d=i/(DPI×3.1416), wherein DPI is used to describe the resolution number of dots per inch for the printer (step 80b). A printer typically has a known DPI measurement, although the DPI measurement may be dependent on print mode, which is usually influenced by driver settings. The range of DPI supported by a printer is most dependent on the print head technology it uses. The waveform signal confirms that the ribbon encoder wheel has rotated a full rotation/revolution. For example, if the ribbon encoder wheel has 36 sectors, the ribbon encoder wheel has rotated a full rotation/revolution when the waveform signal indicates that 36 sectors have passed the optical sensor proximate the ribbon encoder wheel. The number of steps (i) is determined from the stepper motor and the processor is configured to calculate the outer diameter of the ribbon roll using the following equation as noted previously: d=i/(DPI×3.1416). This step calculates the outer diameter of the ribbon roll using the linear distance that the print media has traveled in one rotation/revolution of the ribbon encoder wheel. The ribbon and the print media travel together. It is to be understood that step 70 is unnecessary if the outer diameter of the ribbon roll is calculated using the number of stepper motor steps.

Still referring to FIG. 6, according to various embodiments, the method 10 for determining the amount of print media printable from remaining ribbon on a ribbon supply spool used in a printer continues by calculating a remaining ribbon length (Ribbon_{length}) (step 90). The remaining ribbon length may be calculated from the following equation:

$${Ribbon}_{Length} = \frac{π}{4 Th} [ d {2}^{2} - {di}^{2} ] .$$

Wherein, as noted previously:
di=ribbon roll inner diameter (i.e., ribbon core outer diameter)
d2=ribbon roll outer diameter
Th=ribbon thickness

The step of calculating the remaining ribbon length (step 90) comprises sub-step 90a of calculating a difference in the ribbon roll outer diameter (d1-d2) between t1 and t2, sub-step 90b of determining the number (n) of encoder wheel rotations from a time interval, t1 to t2, and sub-step 90c of calculating a ribbon thickness (Th) from the difference in diameter (d1-d2) and the number of rotations of the ribbon encoder wheel during the same time interval (Rot_{nbr}). The equation for calculating ribbon thickness is as follows:

$$Thickness = \frac{d 1 - d 2}{2 \times {Rot}_{nbr}}$$

Still referring to FIG. 6, according to various embodiments, the method 10 for determining the amount of print media printable from the remaining ribbon length further comprises determining a remaining print media length printable from the remaining ribbon at t2. The “remaining print media” refers to the print media in the media roll that is unused and available for printing to produce “printed media”. For continuous print media when the amount of print media comprises the length of the print media printable from the remaining ribbon length as noted previously, step 90 comprising sub-steps 90a, 90b, and 90c also results in determining the length of remaining print media. Determining the remaining ribbon length in step 90 comprises determining the remaining print media length according to various embodiments (i.e., for method 10, the remaining ribbon length (Ribbon_{length}) calculated in step 90 is substantially equal to a remaining media length (Media_{length})).

Referring still to FIG. 6, according to various embodiments, the method 10 for determining the amount of print media printable with the remaining ribbon in the ribbon roll may further comprise, determining, in the case of non-continuous print media, the quantity of individual print medium (e.g., labels, tickets, etc.) printable from the remaining ribbon length (Ribbon_{Length}) (step 95). The quantity is determined from the following equation:

$$Quantity of labels remaining = Minimum ( \frac{{Ribbon}_{Length}}{{Label}_{length}} , \frac{Media Length}{{Label}_{length}} )$$

The stop sensor of the printer may be used to measure a print medium length (Label_{length}) (e.g., the length of individual labels, tickets, etc. of the non-continuous media in the media roll (there are a plurality of individual print medium in the media roll)). The stop sensor may output a signal representing the length of the individual print medium (Label_{length}). According to various embodiments, the CPU may further be configured to receive the analog signal from the stop sensor (step 95a). As noted previously, the analog signal represents the print medium length of the non-continuous print medium. In response to receiving the analog signal, the CPU may be further configured to calculate the print medium quantity from the above equation (step 95b) i.e., by dividing the remaining ribbon length (Ribbon_{length}) (equivalent to remaining media length (Media_{length}) in method 10 as noted previously) by the print medium length. The print medium quantity refers to the quantity of individual labels, tickets, or other individual print medium that can be printed (i.e., printable) with the remaining ribbon length/remaining print media length. The length of the remaining ribbon and remaining print media may be expressed using metric units, imperial units, as a percentage, or otherwise.

While non-continuous print media in the form of label media has been described, it is to be understood that the amount of other types of print media printable from the remaining ribbon roll may be determined in the same manner according to various embodiments. The length of any type of individual print medium detected by the stop sensor is referred to herein as the Label_{length}. For continuous print media, the media length is supplied by the user or label format data (as opposed to measured).

Still referring to FIG. 6, according to various embodiments, method 10 for determining the amount of print media printable from the remaining ribbon may further comprise generating an alert (step 97) if the length of the remaining ribbon, the length of the remaining print media, the quantity of individual print media, the amount of print media printable therefrom, or a combination thereof, is below a minimum threshold amount. The CPU may be configured to generate the alert. The user may be an audible alert, a visual alert that may appear, for example, on the display of the user interface, etc.

Still referring to FIG. 6, according to various embodiments, method 10 for determining the amount of print media printable from the remaining ribbon may further comprise measuring, by the CPU, at depletion of the ribbon roll, the outer diameter (di) of the ribbon core therein to obtain an updated value of di and updating the remaining ribbon length calculation with the updated value (step 99). As noted previously, the outer diameter of the ribbon core (the ribbon supply spool) is set by the manufacturer but may deviate somewhat. Updating the value of the outer diameter of the ribbon core (di) substantially compensates for the deviation.

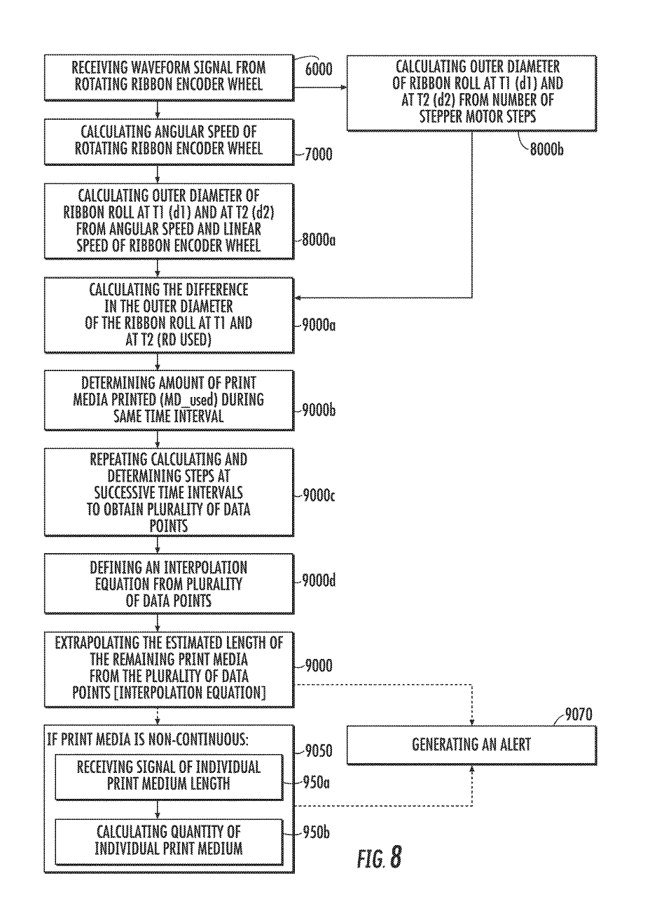

Referring now to FIG. 7, according to various embodiments, a flow diagram of method 100 is provided. Method 100 proceeds in a similar manner to method 10, except that method 100 is directed to determining the amount of print media printable from the remaining print media on the media supply spool used in the printer, rather than determining the amount of print media printable from the remaining ribbon on the ribbon supply spool used in the printer (method 10). The amount of print media printable from the remaining print media on the media supply spool used in the printer is a determinative amount (not an estimated amount). As noted previously, the “remaining print media” refers to the print media in the media roll that is unused and available for printing to produce “printed media”.

Still referring to FIG. 7, according to various embodiments, method 100 for determining the amount of print media printable from the remaining print media on the media supply spool used in the printer begins by receiving the media encoder wheel waveform signal from the media encoder wheel as the media encoder wheel rotates (step 600). As noted previously, the media encoder wheel waveform signal represents the number (n) of sectors on the media encoder wheel that passes by the optical sensor proximate the media encoder wheel during the specified time interval.

Still referring to FIG. 7, according to various embodiments, method 100 for determining the amount of print media printable from the remaining print media on the media supply spool used in the printer continues by calculating the angular speed (ω) of the media encoder wheel 61 at an instant tx (step 700). The processor (CPU) 38 is configured to calculate the angular speed of the media encoder wheel 61. The angular speed of the media encoder wheel 61 is calculated using the following equation:

$$Angular speed ( ω ) = \frac{Angle traveled}{Time taken} = \frac{θ}{t}$$

$$ω ( \frac{rad}{s} ) = \frac{θ}{t} = \frac{2 π}{n} \times \frac{m}{t} \{ \begin{matrix} & n number of sectors in encoder wheel \\ with \text{:} & m number of sectors seen in “ t ” time \\ & t measurement time\end{matrix}$$

Still referring to FIG. 7, according to various embodiments, method 100 for determining the amount of print media printable from the remaining print media on the media supply spool used in the printer continues by calculating an outer diameter of the media roll at t1 (d1) and at t2 (d2) from the angular speed (ω) and a linear speed (ν) of the encoder wheel (step 800a). As noted previously, the linear speed comprises the print speed. The outer diameter of the media roll 20 at t1 and the outer diameter of the media roll 20 at t2 are calculated by the processor (CPU) 38 using the following equation:

$$Media diameter \text{:} d ( mm ) = 2 ( 25.4 \frac{v}{ω} ) = 2 ( 25.4 \frac{v \cdot ( n \cdot t )}{2 π \cdot m} )$$

In various embodiments, if a stepper motor is used to rotate the media supply spindle and the media roll disposed thereon, the outer diameter of the media roll may be calculated from a number of steps (i) of the stepper motor in a single rotation/revolution of the media encoder wheel using the equation: d=i/(DPI×3.1416), wherein DPI is used to describe the resolution number of dots per inch for the printer (step 800b). As noted previously, a printer typically has a known DPI measurement, although the DPI measurement may be dependent on print mode, which is usually influenced by driver settings. The range of DPI supported by a printer is most dependent on the print head technology it uses. The waveform signal confirms that the media encoder wheel has rotated a full rotation/revolution. For example, if the media encoder wheel has 36 sectors, the media encoder wheel has rotated a full rotation/revolution when the waveform signal indicates that 36 sectors have passed the optical sensor proximate the media encoder wheel. The number of steps (i) is determined from the stepper motor and the processor is configured to calculate the outer diameter of the media roll using the following equation as noted previously: d=i/(DPI×3.1416). This step calculates the outer diameter of the media roll using the linear distance that the print media has traveled in one rotation/revolution of the media encoder wheel. It is to be understood that step 700 is unnecessary if the outer diameter of the media roll is calculated using the number of stepper motor steps.

Still referring to FIG. 7, according to various embodiments, method 100 continues by calculating a remaining media length (i.e., a length of the remaining print media) (step 900). The remaining media length (Media_{length}) is calculated using the following equation:

$${Media}_{Length} = \frac{π}{4 Th} [ d {2}^{2} - {di}^{2} ] .$$

Wherein, as noted previously:
di=media roll inner diameter (i.e., media core outer diameter)
d2=media roll outer diameter at instant tx
Th=media thickness

Step 900 of calculating the remaining media length (Media_{length}) comprises sub-step 900a of calculating a difference (d1-d2) in the media roll outer diameter between t1 and t2, sub-step 900b of determining a number of media encoder wheel rotations (Rot_{nbr}) during the same time interval, and sub-step 900c of calculating a media thickness from the difference in media roll outer diameter and the number of rotations of the media encoder wheel during the same time interval. The equation for calculating media thickness is as follows:

$$Thickness = \frac{d 1 - d 2}{2 \times {Rot}_{nbr}}$$

Still referring to FIG. 7, according to various embodiments, the method 100 for determining the amount of print media printable with the remaining print media on the media supply spool may further comprise, determining, in the case of non-continuous print media, the quantity of individual labels, tickets, etc. printable from the remaining media length (step 950). The quantity is determined from the following equation:

$$Quantity of labels remaining = \frac{{Media}_{Length}}{{Label}_{length}}$$

As noted previously, the stop sensor of the printer may be used to detect a print medium length (e.g., the length of individual labels, tickets, etc. of the non-continuous media in the media roll (there are a plurality of individual labels in the media roll)). The stop sensor may output an analog signal representing the length of the individual print medium (Label_{length}). According to various embodiments, the CPU may further be configured to receive the analog signal from the stop sensor (step 950a). As noted previously, the analog signal represents the print medium length of the non-continuous print medium. In response to receiving the analog signal, the CPU may be further configured to calculate the print medium quantity from the above equation i.e., by dividing the remaining media length (Media_{length}) by the individual print medium length (step 950b). The print medium quantity refers to the quantity of individual labels, tickets, or other individual print medium that can be printed (i.e., printable) with the remaining print media length. The length of the remaining ribbon and remaining print media may be expressed using metric units, imperial units, as a percentage, or otherwise.

Again, while non-continuous print media in the form of label media has been described, it is to be understood that the amount of other types of print media printable from the remaining ribbon roll may be determined in the same manner according to various embodiments. The length of any type of individual print medium detected by the stop sensor is referred to herein as the Label_{length}.

Still referring to FIG. 7, according to various embodiments, method 100 for determining the amount of print media printable from the remaining print media may further comprise generating an alert if the length of the remaining ribbon, the length of the remaining print media, the quantity of individual print media, the amount of print media printable therefrom, or a combination thereof, is below a minimum threshold amount (step 970). The alert may be an audible alert, a visual alert, or otherwise that may appear, for example, on the display of the user interface, etc.

Still referring to FIG. 7, according to various embodiments, method 100 for determining the amount of print media printable from the remaining print media may further comprise measuring, at depletion of the media roll, the outer diameter (di) of the media core therein to obtain an updated value of di and updating the remaining media length calculation with the updated value (step 990). As noted previously, updating the value of di compensates for the deviation in the core outer diameter from the manufacturer's specification.

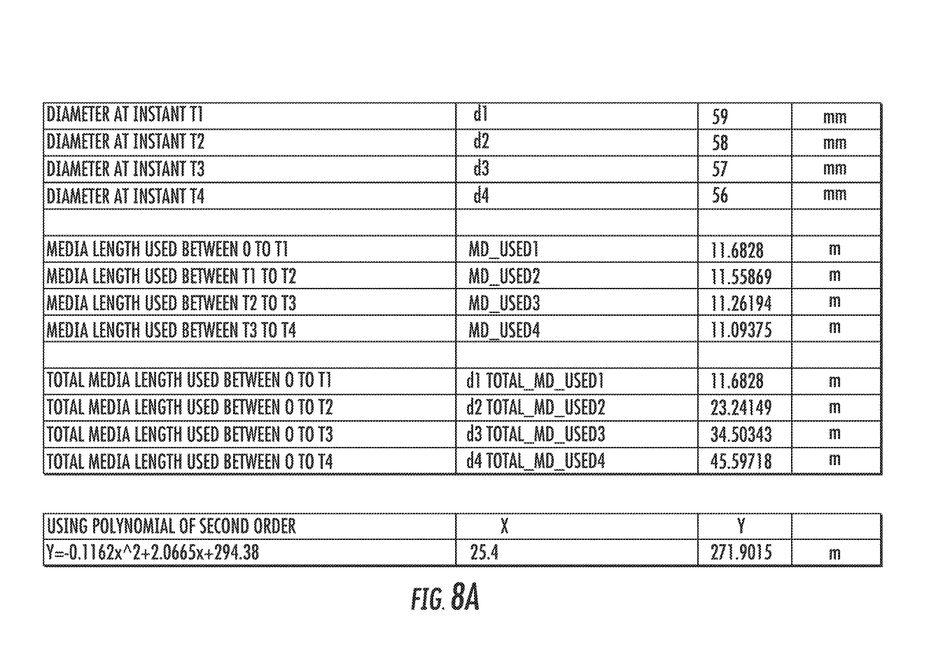

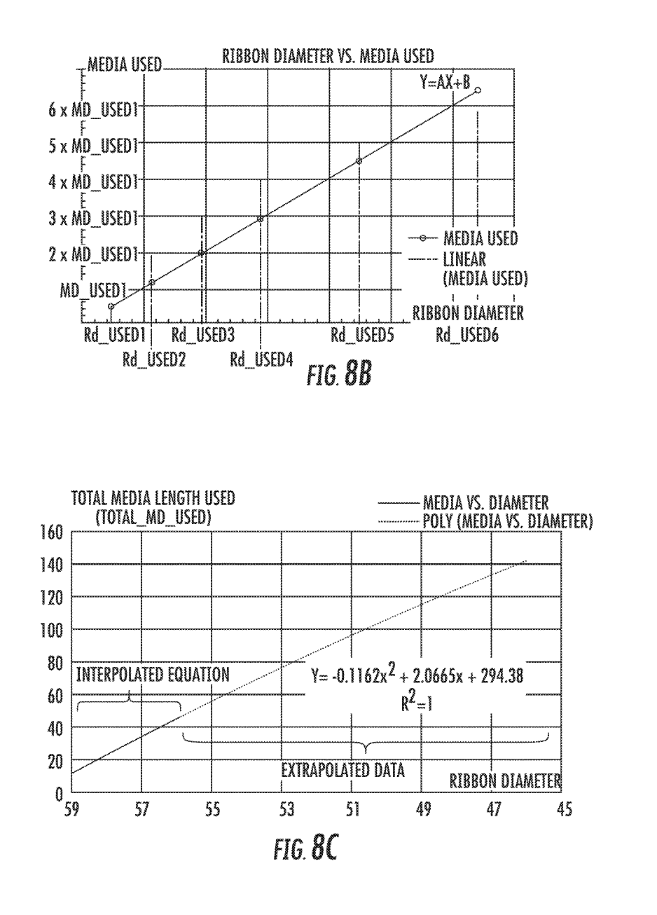

Referring now to FIG. 8, according to various embodiments, a method 1000 for determining an amount of print media printable from the remaining ribbon on the ribbon supply spool used in an operating printer is illustrated. The amount of print media printable from the remaining ribbon determined by method 1000 comprises an estimated amount (not a determinative amount).

Still referring to FIG. 8, according to various embodiments, the method 1000 for determining the estimated amount of print media printable from the remaining ribbon on the ribbon supply spool begins by receiving the ribbon encoder waveform signal (step 6000) from the ribbon encoder wheel (48 in FIGS. 5 and 5A) as the ribbon encoder wheel rotates, the ribbon encoder wheel waveform signal comprising the number of sectors passing by the optical sensor proximate the rotating ribbon encoder wheel during the specified time interval.

Still referring to FIG. 8, according to various embodiments, the method 1000 for determining the estimated amount of print media printable from the remaining ribbon may continue by the CPU calculating an angular speed (ω in rad/s) of the ribbon encoder wheel (step 7000) using the following equation:

$$Angular speed ( ω ) = \frac{Angle traveled}{Time taken} = \frac{θ}{t}$$

$$ω ( \frac{rad}{s} ) = \frac{θ}{t} = \frac{2 π}{n} \times \frac{m}{t} \{ \begin{matrix} & n number of sectors in encoder wheel \\ with \text{:} & m number of sectors seen in “ t ” time \\ & t measurement time\end{matrix}$$

Still referring to FIG. 8, according to various embodiments, the method 1000 for determining the estimated amount of print media printable from the remaining ribbon continues by calculating the outer diameter (d) of the ribbon roll at successive instant times (tn) (e.g., instant t1 (d1), instant t2 (d2), instant t3 (d3), instant t4 (d4), etc.) using the calculated angular speed (ω) and the linear speed and using the following equation as noted previously (step 8000a):

$$Ribbon diameter \text{:} d ( mm ) = 2 ( 25.4 \frac{v}{ω} ) = 2 ( 25.4 \frac{v \cdot ( n \cdot t )}{2 π \cdot m} )$$

The linear speed (v in, for example, inches per second (ips)) is the print speed. The CPU is configured to calculate the ribbon diameter at each instant time.

In various embodiments in which a stepper motor is used in the printer to rotate the media supply spindle and media roll disposed thereon, the outer diameter of the ribbon roll 16 may alternatively be calculated from a number of steps (i) of the stepper motor in a single rotation/revolution of the ribbon encoder wheel using the equation: d=i/(DPI×3.1416), wherein DPI is used to describe the resolution number of dots per inch for the printer (step 8000b). A printer typically has a known DPI measurement, although the DPI measurement may be dependent on print mode, which is usually influenced by driver settings. The range of DPI supported by a printer is most dependent on the print head technology it uses. The waveform signal confirms that the ribbon encoder wheel has rotated a full rotation/revolution. For example, if the ribbon encoder wheel has 36 sectors, the ribbon encoder wheel has rotated a full rotation/revolution when the waveform signal indicates that 36 sectors have passed the optical sensor proximate the ribbon encoder wheel. The number of steps (i) is determined from the stepper motor and the processor is configured to calculate the outer diameter of the ribbon roll using the following equation as noted previously: d=i/(DPI×3.1416). This step calculates the outer diameter of the ribbon roll using the linear distance that the print media has traveled in one rotation/revolution of the ribbon encoder wheel. The ribbon and the print media travel together. It is to be understood that step 7000 is unnecessary if the outer diameter of the ribbon roll is calculated using the number of stepper motor steps.

Still referring to FIG. 8, according to various embodiments, the method 1000 for determining the estimated amount of print media printable from the remaining ribbon continues by calculating the difference in the outer diameter (d) of the ribbon roll at instant tn and at instant tn (step 9000a) (e.g., d1-d2; d3-d4, d4-d5, etc.) (also referred to herein as (Rd_used)).

Still referring to FIG. 8, according to various embodiments, the method 1000 for determining the estimated amount of print media printable from the remaining ribbon continues by determining the amount of print media printed (Md_used) during a time interval from instant tn to instant tn (step 9000b).

Still referring to FIG. 8, according to various embodiments, the method 1000 for determining the estimated amount of print media printable from the remaining ribbon continues by repeating the steps of calculating the difference in the outer diameter of the ribbon roll and determining the amount of print media printed (Md_used) at successive time intervals to obtain a plurality of data points (step 9000c). Each data point comprises the difference (e.g., d1-d2) in the outer diameter of the ribbon roll at instant tn and at instant tn (Rd_used) and the amount of print media printed (Md_used) between the instant times (i.e., during the same time interval as the outer diameter is calculated). Ms_used may be the length of the remaining print media or the quantity of individual print medium.

FIG. 8A is a table including exemplary calculated values for the outer diameter (d) of the ribbon roll at successive instant times (tn) and the media length used (Md_used) in successive time intervals between the successive instant times. FIG. 8B also includes the total media length used (Total_Md_used). As used in the Table, the term “between” refers to time intervals up to and including the instant time endpoints. While the table of FIG. 8A and the plots of FIGS. 8B and 8C include exemplary specific values, it is to be understood that the diameter, media length used, total media length, and the interpolation equation defined may vary depending upon the specifics of the ribbon roll and the media roll. Still referring to FIG. 8, for ease of understanding, the plurality of data points may be plotted using a linear regression plot such as shown in FIG. 8B. As depicted in FIG. 8B, the difference in the outer diameter (d) of the ribbon roll between instant time tn and tn (Rd_used) (e.g., “d1-d2”) may be on the x-axis with print media length used (Md__{^{used}}) between successive time intervals on the y-axis. FIG. 8C plots the following exemplary data points from Table 8A: (d1, Total_Md_used1), (d2, Total_Md_used2), (d3, Total_Md_used3), and (d4, Total_Md_used4). It is to be understood that plotting of the plurality of data points is not necessary in the method 1000 for determining the amount of print media printable from remaining ribbon on the ribbon supply spool.

Still referring to FIG. 8, according to various embodiments, the method 1000 for determining the estimated amount of print media printable from the remaining ribbon continues by defining an interpolation equation from the plurality of data points (step 9000d). The interpolation equation may be linear, polynomial, logarithmic, etc. The interpolation equation defines the relationship between the media length used (Md_used) per ribbon diameter used (Rd_used): Md_{usedx}=F(Rd_{usedx}). Estimating the amount of print media printable from the remaining ribbon through calculation comprises approximating the relationship between the media length used and the ribbon diameter used by the linear, polynomial, logarithmic equation. For example, an exemplary polynomial equation of a second order is shown in FIG. 8A. For a second order equation, y=ax²+bx+c, at least three data points are needed to find the coefficients a, b, and c. Y is the vertical axis on the graph (Media_used) and X is the horizontal axis (Ribbon_used).

Still referring to FIG. 8, according to various embodiments, the method 1000 for determining the estimated amount of print media printable from the remaining ribbon continues by extrapolating the (estimated) length of the remaining print media from the interpolation equation (step 9000) defined by performing steps 9000a through 9000e. The equation is used to find the total media length used when the outer diameter of the ribbon roll is equal to a certain diameter at an instant tx in the future. As the ribbon roll outer diameter (d) decreases, the circumference of the ribbon roll also decreases. Therefore, to print the same amount of print media (length or quantity) throughout the ribbon roll, an additional ribbon length is used. Therefore, the difference in ribbon diameter also increases as shown in FIGS. 8B and 8C.

To substantially ensure the continued accuracy of the interpolation equation, the data points may be continuously collected with the interpolation equation updated as necessary based on the continuously collected data points. The more data points collected, the better the interpolation equation, thereby increasing the accuracy of the value of the estimated amount of print media printable from the remaining ribbon at any instant tx.

As in method 10 and method 100, method 1000 for determining the (estimated) amount of print medium printable from the remaining ribbon may further comprise determining the quantity of individual medium printable from the remaining ribbon using the following equation after the stop sensor has determined the length of, for example, the individual labels, tickets, etc. of non-continuous media:

$$Quantity of labels remaining = \frac{{Ribbon}_{Length}}{{Label}_{length}}$$

As noted previously, the stop sensor of the printer may be used to detect the individual print medium length (Label_{length}) (e.g., the length of individual labels, tickets, etc. of the non-continuous media in the media roll (there are a plurality of individual labels in the media roll)). While non-continuous print media in the form of label media has been described, it is to be understood that the amount of other types of print media printable from the remaining media may be determined in the same manner according to various embodiments. Referring again to FIG. 5, according to various embodiments, the stop sensor 46 may output the analog signal representing the length of the individual print medium (Label_{length}). According to various embodiments, the CPU may further be configured to receive the analog signal from the stop sensor (step 9050a). As noted previously, the analog signal represents the individual print medium length of the non-continuous print medium. In response to receiving the analog signal, the CPU may be further configured to calculate the print medium quantity from the above equation i.e., by dividing the remaining ribbon length (Ribbon_{length}) by the individual print medium length (step 9050b). The print medium quantity refers to the quantity of individual labels, tickets, or other individual print medium that can be printed (i.e., printable) with the remaining ribbon length/remaining print media length (e.g., the number of individual labels). The length of the remaining ribbon and remaining print media may be expressed using metric units, imperial units, as a percentage, or otherwise.

Still referring to FIG. 8, according to various embodiments, method 1000 for determining the (estimated) amount of print media printable from the remaining ribbon may further comprise generating an alert if the length of the remaining print media, the quantity of individual print media, or a combination thereof, is below a minimum threshold amount (step 9070). The alert may be an audible alert, a visual alert, or otherwise. The alert may appear on display of user interface.

Various embodiments may be used to accurately and efficiently determine the amount of print media that can be printed (i.e., printable) from remaining ribbon/remaining print media on a supply spool used in a printer. Various embodiments provide the amount of print media printable from the remaining ribbon/remaining print media in a user-friendly way.

To supplement the present disclosure, this application incorporates entirely by reference the following commonly assigned patents, patent application publications, and patent applications:
U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,525;
U.S. Pat. No. 8,794,526; U.S. Pat. No. 8,798,367;
U.S. Pat. No. 8,807,431; U.S. Pat. No. 8,807,432;
U.S. Pat. No. 8,820,630; U.S. Pat. No. 8,822,848;
U.S. Pat. No. 8,824,692; U.S. Pat. No. 8,824,696;
U.S. Pat. No. 8,842,849; U.S. Pat. No. 8,844,822;
U.S. Pat. No. 8,844,823; U.S. Pat. No. 8,849,019;
U.S. Pat. No. 8,851,383; U.S. Pat. No. 8,854,633;
U.S. Pat. No. 8,866,963; U.S. Pat. No. 8,868,421;
U.S. Pat. No. 8,868,519; U.S. Pat. No. 8,868,802;
U.S. Pat. No. 8,868,803; U.S. Pat. No. 8,870,074;
U.S. Pat. No. 8,879,639; U.S. Pat. No. 8,880,426;
U.S. Pat. No. 8,881,983; U.S. Pat. No. 8,881,987;
U.S. Pat. No. 8,903,172; U.S. Pat. No. 8,908,995;
U.S. Pat. No. 8,910,870; U.S. Pat. No. 8,910,875;
U.S. Pat. No. 8,914,290; U.S. Pat. No. 8,914,788;
U.S. Pat. No. 8,915,439; U.S. Pat. No. 8,915,444;
U.S. Pat. No. 8,916,789; U.S. Pat. No. 8,918,250;
U.S. Pat. No. 8,918,564; U.S. Pat. No. 8,925,818;
U.S. Pat. No. 8,939,374; U.S. Pat. No. 8,942,480;
U.S. Pat. No. 8,944,313; U.S. Pat. No. 8,944,327;
U.S. Pat. No. 8,944,332; U.S. Pat. No. 8,950,678;
U.S. Pat. No. 8,967,468; U.S. Pat. No. 8,971,346;
U.S. Pat. No. 8,976,030; U.S. Pat. No. 8,976,368;
U.S. Pat. No. 8,978,981; U.S. Pat. No. 8,978,983;
U.S. Pat. No. 8,978,984; U.S. Pat. No. 8,985,456;
U.S. Pat. No. 8,985,457; U.S. Pat. No. 8,985,459;
U.S. Pat. No. 8,985,461; U.S. Pat. No. 8,988,578;
U.S. Pat. No. 8,988,590; U.S. Pat. No. 8,991,704;
U.S. Pat. No. 8,996,194; U.S. Pat. No. 8,996,384;
U.S. Pat. No. 9,002,641; U.S. Pat. No. 9,007,368;
U.S. Pat. No. 9,010,641; U.S. Pat. No. 9,015,513;
U.S. Pat. No. 9,016,576; U.S. Pat. No. 9,022,288;
U.S. Pat. No. 9,030,964; U.S. Pat. No. 9,033,240;
U.S. Pat. No. 9,033,242; U.S. Pat. No. 9,036,054;
U.S. Pat. No. 9,037,344; U.S. Pat. No. 9,038,911;
U.S. Pat. No. 9,038,915; U.S. Pat. No. 9,047,098;
U.S. Pat. No. 9,047,359; U.S. Pat. No. 9,047,420;
U.S. Pat. No. 9,047,525; U.S. Pat. No. 9,047,531;
U.S. Pat. No. 9,053,055; U.S. Pat. No. 9,053,378;
U.S. Pat. No. 9,053,380; U.S. Pat. No. 9,058,526;
U.S. Pat. No. 9,064,165; U.S. Pat. No. 9,064,167;
U.S. Pat. No. 9,064,168; U.S. Pat. No. 9,064,254;
U.S. Pat. No. 9,066,032; U.S. Pat. No. 9,070,032;
U.S. Design Pat. No. D716,285;
U.S. Design Pat. No. D723,560;
U.S. Design Pat. No. D730,357;
U.S. Design Pat. No. D730,901;
U.S. Design Pat. No. D730,902;
U.S. Design Pat. No. D733,112;
U.S. Design Pat. No. D734,339;
International Publication No. 2013/163789;
International Publication No. 2013/173985;
International Publication No. 2014/019130;
International Publication No. 2014/110495;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2010/0265880;
U.S. Patent Application Publication No. 2011/0202554;
U.S. Patent Application Publication No. 2012/0111946;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0287258;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0313325;
U.S. Patent Application Publication No. 2013/0342717;
U.S. Patent Application Publication No. 2014/0001267;
U.S. Patent Application Publication No. 2014/0008439;
U.S. Patent Application Publication No. 2014/0025584;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0042814;
U.S. Patent Application Publication No. 2014/0049120;
U.S. Patent Application Publication No. 2014/0049635;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0076974;
U.S. Patent Application Publication No. 2014/0078341;
U.S. Patent Application Publication No. 2014/0078345;
U.S. Patent Application Publication No. 2014/0097249;
U.S. Patent Application Publication No. 2014/0098792;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0104451;
U.S. Patent Application Publication No. 2014/0106594;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0110485;
U.S. Patent Application Publication No. 2014/0114530;
U.S. Patent Application Publication No. 2014/0124577;
U.S. Patent Application Publication No. 2014/0124579;
U.S. Patent Application Publication No. 2014/0125842;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131438;
U.S. Patent Application Publication No. 2014/0131441;
U.S. Patent Application Publication No. 2014/0131443;
U.S. Patent Application Publication No. 2014/0131444;
U.S. Patent Application Publication No. 2014/0131445;
U.S. Patent Application Publication No. 2014/0131448;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0151453;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0166755;
U.S. Patent Application Publication No. 2014/0166759;
U.S. Patent Application Publication No. 2014/0168787;
U.S. Patent Application Publication No. 2014/0175165;
U.S. Patent Application Publication No. 2014/0175172;
U.S. Patent Application Publication No. 2014/0191644;
U.S. Patent Application Publication No. 2014/0191913;
U.S. Patent Application Publication No. 2014/0197238;
U.S. Patent Application Publication No. 2014/0197239;
U.S. Patent Application Publication No. 2014/0197304;
U.S. Patent Application Publication No. 2014/0214631;
U.S. Patent Application Publication No. 2014/0217166;
U.S. Patent Application Publication No. 2014/0217180;
U.S. Patent Application Publication No. 2014/0231500;
U.S. Patent Application Publication No. 2014/0232930;
U.S. Patent Application Publication No. 2014/0247315;
U.S. Patent Application Publication No. 2014/0263493;
U.S. Patent Application Publication No. 2014/0263645;
U.S. Patent Application Publication No. 2014/0267609;
U.S. Patent Application Publication No. 2014/0270196;
U.S. Patent Application Publication No. 2014/0270229;
U.S. Patent Application Publication No. 2014/0278387;
U.S. Patent Application Publication No. 2014/0278391;
U.S. Patent Application Publication No. 2014/0282210;
U.S. Patent Application Publication No. 2014/0284384;
U.S. Patent Application Publication No. 2014/0288933;
U.S. Patent Application Publication No. 2014/0297058;
U.S. Patent Application Publication No. 2014/0299665;
U.S. Patent Application Publication No. 2014/0312121;
U.S. Patent Application Publication No. 2014/0319220;
U.S. Patent Application Publication No. 2014/0319221;
U.S. Patent Application Publication No. 2014/0326787;
U.S. Patent Application Publication No. 2014/0332590;
U.S. Patent Application Publication No. 2014/0344943;
U.S. Patent Application Publication No. 2014/0346233;
U.S. Patent Application Publication No. 2014/0351317;
U.S. Patent Application Publication No. 2014/0353373;
U.S. Patent Application Publication No. 2014/0361073;
U.S. Patent Application Publication No. 2014/0361082;
U.S. Patent Application Publication No. 2014/0362184;
U.S. Patent Application Publication No. 2014/0363015;
U.S. Patent Application Publication No. 2014/0369511;
U.S. Patent Application Publication No. 2014/0374483;
U.S. Patent Application Publication No. 2014/0374485;
U.S. Patent Application Publication No. 2015/0001301;
U.S. Patent Application Publication No. 2015/0001304;
U.S. Patent Application Publication No. 2015/0003673;
U.S. Patent Application Publication No. 2015/0009338;
U.S. Patent Application Publication No. 2015/0009610;
U.S. Patent Application Publication No. 2015/0014416;
U.S. Patent Application Publication No. 2015/0021397;
U.S. Patent Application Publication No. 2015/0028102;
U.S. Patent Application Publication No. 2015/0028103;
U.S. Patent Application Publication No. 2015/0028104;
U.S. Patent Application Publication No. 2015/0029002;
U.S. Patent Application Publication No. 2015/0032709;
U.S. Patent Application Publication No. 2015/0039309;
U.S. Patent Application Publication No. 2015/0039878;
U.S. Patent Application Publication No. 2015/0040378;
U.S. Patent Application Publication No. 2015/0048168;
U.S. Patent Application Publication No. 2015/0049347;
U.S. Patent Application Publication No. 2015/0051992;
U.S. Patent Application Publication No. 2015/0053766;
U.S. Patent Application Publication No. 2015/0053768;
U.S. Patent Application Publication No. 2015/0053769;
U.S. Patent Application Publication No. 2015/0060544;
U.S. Patent Application Publication No. 2015/0062366;
U.S. Patent Application Publication No. 2015/0063215;
U.S. Patent Application Publication No. 2015/0063676;
U.S. Patent Application Publication No. 2015/0069130;
U.S. Patent Application Publication No. 2015/0071819;
U.S. Patent Application Publication No. 2015/0083800;
U.S. Patent Application Publication No. 2015/0086114;
U.S. Patent Application Publication No. 2015/0088522;
U.S. Patent Application Publication No. 2015/0096872;
U.S. Patent Application Publication No. 2015/0099557;
U.S. Patent Application Publication No. 2015/0100196;
U.S. Patent Application Publication No. 2015/0102109;
U.S. Patent Application Publication No. 2015/0115035;
U.S. Patent Application Publication No. 2015/0127791;
U.S. Patent Application Publication No. 2015/0128116;
U.S. Patent Application Publication No. 2015/0129659;
U.S. Patent Application Publication No. 2015/0133047;
U.S. Patent Application Publication No. 2015/0134470;
U.S. Patent Application Publication No. 2015/0136851;
U.S. Patent Application Publication No. 2015/0136854;
U.S. Patent Application Publication No. 2015/0142492;
U.S. Patent Application Publication No. 2015/0144692;
U.S. Patent Application Publication No. 2015/0144698;
U.S. Patent Application Publication No. 2015/0144701;
U.S. Patent Application Publication No. 2015/0149946;
U.S. Patent Application Publication No. 2015/0161429;
U.S. Patent Application Publication No. 2015/0169925;
U.S. Patent Application Publication No. 2015/0169929;
U.S. Patent Application Publication No. 2015/0178523;
U.S. Patent Application Publication No. 2015/0178534;
U.S. Patent Application Publication No. 2015/0178535;
U.S. Patent Application Publication No. 2015/0178536;
U.S. Patent Application Publication No. 2015/0178537;
U.S. Patent Application Publication No. 2015/0181093;
U.S. Patent Application Publication No. 2015/0181109;
U.S. patent application Ser. No. 13/367,978 for a Laser Scanning Module Employing an Elastomeric U-Hinge Based Laser Scanning Assembly, filed Feb. 7, 2012 (Feng et al.);
U.S. patent application Ser. No. 29/458,405 for an Electronic Device, filed Jun. 19, 2013 (Fitch et al.);
U.S. patent application Ser. No. 29/459,620 for an Electronic Device Enclosure, filed Jul. 2, 2013 (London et al.);
U.S. patent application Ser. No. 29/468,118 for an Electronic Device Case, filed Sep. 26, 2013 (Oberpriller et al.);
U.S. patent application Ser. No. 14/150,393 for Indicia-reader Having Unitary Construction Scanner, filed Jan. 8, 2014 (Colavito et al.);
U.S. patent application Ser. No. 14/200,405 for Indicia Reader for Size-Limited Applications filed Mar. 7, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application Ser. No. 29/486,759 for an Imaging Terminal, filed Apr. 2, 2014 (Oberpriller et al.);
U.S. patent application Ser. No. 14/257,364 for Docking System and Method Using Near Field Communication filed Apr. 21, 2014 (Showering);
U.S. patent application Ser. No. 14/264,173 for Autofocus Lens System for Indicia Readers filed Apr. 29, 2014 (Ackley et al.);
U.S. patent application Ser. No. 14/277,337 for MULTIPURPOSE OPTICAL READER, filed May 14, 2014 (Jovanovski et al.);
U.S. patent application Ser. No. 14/283,282 for TERMINAL HAVING ILLUMINATION AND FOCUS CONTROL filed May 21, 2014 (Liu et al.);
U.S. patent application Ser. No. 14/327,827 for a MOBILE-PHONE ADAPTER FOR ELECTRONIC TRANSACTIONS, filed Jul. 10, 2014 (Hejl);
U.S. patent application Ser. No. 14/334,934 for a SYSTEM AND METHOD FOR INDICIA VERIFICATION, filed Jul. 18, 2014 (Hejl);
U.S. patent application Ser. No. 14/339,708 for LASER SCANNING CODE SYMBOL READING SYSTEM, filed Jul. 24, 2014 (Xian et al.);
U.S. patent application Ser. No. 14/340,627 for an AXIALLY REINFORCED FLEXIBLE SCAN ELEMENT, filed Jul. 25, 2014 (Rueblinger et al.);
U.S. patent application Ser. No. 14/446,391 for MULTIFUNCTION POINT OF SALE APPARATUS WITH OPTICAL SIGNATURE CAPTURE filed Jul. 30, 2014 (Good et al.);
U.S. patent application Ser. No. 14/452,697 for INTERACTIVE INDICIA READER, filed Aug. 6, 2014 (Todeschini);
U.S. patent application Ser. No. 14/453,019 for DIMENSIONING SYSTEM WITH GUIDED ALIGNMENT, filed Aug. 6, 2014 (Li et al.);
U.S. patent application Ser. No. 14/462,801 for MOBILE COMPUTING DEVICE WITH DATA COGNITION SOFTWARE, filed on Aug. 19, 2014 (Todeschini et al.);
U.S. patent application Ser. No. 14/483,056 for VARIABLE DEPTH OF FIELD BARCODE SCANNER filed Sep. 10, 2014 (McCloskey et al.);
U.S. patent application Ser. No. 14/513,808 for IDENTIFYING INVENTORY ITEMS IN A STORAGE FACILITY filed Oct. 14, 2014 (Singel et al.);
U.S. patent application Ser. No. 14/519,195 for HANDHELD DIMENSIONING SYSTEM WITH FEEDBACK filed Oct. 21, 2014 (Laffargue et al.);
U.S. patent application Ser. No. 14/519,179 for DIMENSIONING SYSTEM WITH MULTIPATH INTERFERENCE MITIGATION filed Oct. 21, 2014 (Thuries et al.);
U.S. patent application Ser. No. 14/519,211 for SYSTEM AND METHOD FOR DIMENSIONING filed Oct. 21, 2014 (Ackley et al.);
U.S. patent application Ser. No. 14/519,233 for HANDHELD DIMENSIONER WITH DATA-QUALITY INDICATION filed Oct. 21, 2014 (Laffargue et al.);
U.S. patent application Ser. No. 14/519,249 for HANDHELD DIMENSIONING SYSTEM WITH MEASUREMENT-CONFORMANCE FEEDBACK filed Oct. 21, 2014 (Ackley et al.);
U.S. patent application Ser. No. 14/527,191 for METHOD AND SYSTEM FOR RECOGNIZING SPEECH USING WILDCARDS IN AN EXPECTED RESPONSE filed Oct. 29, 2014 (Braho et al.);
U.S. patent application Ser. No. 14/529,563 for ADAPTABLE INTERFACE FOR A MOBILE COMPUTING DEVICE filed Oct. 31, 2014 (Schoon et al.);
U.S. patent application Ser. No. 14/529,857 for BARCODE READER WITH SECURITY FEATURES filed Oct. 31, 2014 (Todeschini et al.);
U.S. patent application Ser. No. 14/398,542 for PORTABLE ELECTRONIC DEVICES HAVING A SEPARATE LOCATION TRIGGER UNIT FOR USE IN CONTROLLING AN APPLICATION UNIT filed Nov. 3, 2014 (Bian et al.);
U.S. patent application Ser. No. 14/531,154 for DIRECTING AN INSPECTOR THROUGH AN INSPECTION filed Nov. 3, 2014 (Miller et al.);
U.S. patent application Ser. No. 14/533,319 for BARCODE SCANNING SYSTEM USING WEARABLE DEVICE WITH EMBEDDED CAMERA filed Nov. 5, 2014 (Todeschini);
U.S. patent application Ser. No. 14/535,764 for CONCATENATED EXPECTED RESPONSES FOR SPEECH RECOGNITION filed Nov. 7, 2014 (Braho et al.);
U.S. patent application Ser. No. 14/568,305 for AUTO-CONTRAST VIEWFINDER FOR AN INDICIA READER filed Dec. 12, 2014 (Todeschini);
U.S. patent application Ser. No. 14/573,022 for DYNAMIC DIAGNOSTIC INDICATOR GENERATION filed Dec. 17, 2014 (Goldsmith);
U.S. patent application Ser. No. 14/578,627 for SAFETY SYSTEM AND METHOD filed Dec. 22, 2014 (Ackley et al.);
U.S. patent application Ser. No. 14/580,262 for MEDIA GATE FOR THERMAL TRANSFER PRINTERS filed Dec. 23, 2014 (Bowles);
U.S. patent application Ser. No. 14/590,024 for SHELVING AND PACKAGE LOCATING SYSTEMS FOR DELIVERY VEHICLES filed Jan. 6, 2015 (Payne);
U.S. patent application Ser. No. 14/596,757 for SYSTEM AND METHOD FOR DETECTING BARCODE PRINTING ERRORS filed Jan. 14, 2015 (Ackley);
U.S. patent application Ser. No. 14/416,147 for OPTICAL READING APPARATUS HAVING VARIABLE SETTINGS filed Jan. 21, 2015 (Chen et al.);
U.S. patent application Ser. No. 14/614,706 for DEVICE FOR SUPPORTING AN ELECTRONIC TOOL ON A USER'S HAND filed Feb. 5, 2015 (Oberpriller et al.);
U.S. patent application Ser. No. 14/614,796 for CARGO APPORTIONMENT TECHNIQUES filed Feb. 5, 2015 (Morton et al.);
U.S. patent application Ser. No. 29/516,892 for TABLE COMPUTER filed Feb. 6, 2015 (Bidwell et al.);
U.S. patent application Ser. No. 14/619,093 for METHODS FOR TRAINING A SPEECH RECOGNITION SYSTEM filed Feb. 11, 2015 (Pecorari);
U.S. patent application Ser. No. 14/628,708 for DEVICE, SYSTEM, AND METHOD FOR DETERMINING THE STATUS OF CHECKOUT LANES filed Feb. 23, 2015 (Todeschini);
U.S. patent application Ser. No. 14/630,841 for TERMINAL INCLUDING IMAGING ASSEMBLY filed Feb. 25, 2015 (Gomez et al.);
U.S. patent application Ser. No. 14/635,346 for SYSTEM AND METHOD FOR RELIABLE STORE-AND-FORWARD DATA HANDLING BY ENCODED INFORMATION READING TERMINALS filed Mar. 2, 2015 (Sevier);
U.S. patent application Ser. No. 29/519,017 for SCANNER filed Mar. 2, 2015 (Zhou et al.);
U.S. patent application Ser. No. 14/405,278 for DESIGN PATTERN FOR SECURE STORE filed Mar. 9, 2015 (Zhu et al.);
U.S. patent application Ser. No. 14/660,970 for DECODABLE INDICIA READING TERMINAL WITH COMBINED ILLUMINATION filed Mar. 18, 2015 (Kearney et al.);
U.S. patent application Ser. No. 14/661,013 for REPROGRAMMING SYSTEM AND METHOD FOR DEVICES INCLUDING PROGRAMMING SYMBOL filed Mar. 18, 2015 (Soule et al.);
U.S. patent application Ser. No. 14/662,922 for MULTIFUNCTION POINT OF SALE SYSTEM filed Mar. 19, 2015 (Van Horn et al.);
U.S. patent application Ser. No. 14/663,638 for VEHICLE MOUNT COMPUTER WITH CONFIGURABLE IGNITION SWITCH BEHAVIOR filed Mar. 20, 2015 (Davis et al.);
U.S. patent application Ser. No. 14/664,063 for METHOD AND APPLICATION FOR SCANNING A BARCODE WITH A SMART DEVICE WHILE CONTINUOUSLY RUNNING AND DISPLAYING AN APPLICATION ON THE SMART DEVICE DISPLAY filed Mar. 20, 2015 (Todeschini);
U.S. patent application Ser. No. 14/669,280 for TRANSFORMING COMPONENTS OF A WEB PAGE TO VOICE PROMPTS filed Mar. 26, 2015 (Funyak et al.);
U.S. patent application Ser. No. 14/674,329 for AIMER FOR BARCODE SCANNING filed Mar. 31, 2015 (Bidwell);
U.S. patent application Ser. No. 14/676,109 for INDICIA READER filed Apr. 1, 2015 (Huck);
U.S. patent application Ser. No. 14/676,327 for DEVICE MANAGEMENT PROXY FOR SECURE DEVICES filed Apr. 1, 2015 (Yeakley et al.);
U.S. patent application Ser. No. 14/676,898 for NAVIGATION SYSTEM CONFIGURED TO INTEGRATE MOTION SENSING DEVICE INPUTS filed Apr. 2, 2015 (Showering);
U.S. patent application Ser. No. 14/679,275 for DIMENSIONING SYSTEM CALIBRATION SYSTEMS AND METHODS filed Apr. 6, 2015 (Laffargue et al.);
U.S. patent application Ser. No. 29/523,098 for HANDLE FOR A TABLET COMPUTER filed Apr. 7, 2015 (Bidwell et al.);
U.S. patent application Ser. No. 14/682,615 for SYSTEM AND METHOD FOR POWER MANAGEMENT OF MOBILE DEVICES filed Apr. 9, 2015 (Murawski et al.);
U.S. patent application Ser. No. 14/686,822 for MULTIPLE PLATFORM SUPPORT SYSTEM AND METHOD filed Apr. 15, 2015 (Qu et al.);
U.S. patent application Ser. No. 14/687,289 for SYSTEM FOR COMMUNICATION VIA A PERIPHERAL HUB filed Apr. 15, 2015 (Kohtz et al.);
U.S. patent application Ser. No. 29/524,186 for SCANNER filed Apr. 17, 2015 (Zhou et al.);
U.S. patent application Ser. No. 14/695,364 for MEDICATION MANAGEMENT SYSTEM filed Apr. 24, 2015 (Sewell et al.);
U.S. patent application Ser. No. 14/695,923 for SECURE UNATTENDED NETWORK AUTHENTICATION filed Apr. 24, 2015 (Kubler et al.);
U.S. patent application Ser. No. 29/525,068 for TABLET COMPUTER WITH REMOVABLE SCANNING DEVICE filed Apr. 27, 2015 (Schulte et al.);
U.S. patent application Ser. No. 14/699,436 for SYMBOL READING SYSTEM HAVING PREDICTIVE DIAGNOSTICS filed Apr. 29, 2015 (Nahill et al.);
U.S. patent application Ser. No. 14/702,110 for SYSTEM AND METHOD FOR REGULATING BARCODE DATA INJECTION INTO A RUNNING APPLICATION ON A SMART DEVICE filed May 1, 2015 (Todeschini et al.);
U.S. patent application Ser. No. 14/702,979 for TRACKING BATTERY CONDITIONS filed May 4, 2015 (Young et al.);
U.S. patent application Ser. No. 14/704,050 for INTERMEDIATE LINEAR POSITIONING filed May 5, 2015 (Charpentier et al.);
U.S. patent application Ser. No. 14/705,012 for HANDS-FREE HUMAN MACHINE INTERFACE RESPONSIVE TO A DRIVER OF A VEHICLE filed May 6, 2015 (Fitch et al.);
U.S. patent application Ser. No. 14/705,407 for METHOD AND SYSTEM TO PROTECT SOFTWARE-BASED NETWORK-CONNECTED DEVICES FROM ADVANCED PERSISTENT THREAT filed May 6, 2015 (Hussey et al.);
U.S. patent application Ser. No. 14/707,037 for SYSTEM AND METHOD FOR DISPLAY OF INFORMATION USING A VEHICLE-MOUNT COMPUTER filed May 8, 2015 (Chamberlin);
U.S. patent application Ser. No. 14/707,123 for APPLICATION INDEPENDENT DEX/UCS INTERFACE filed May 8, 2015 (Pape);
U.S. patent application Ser. No. 14/707,492 for METHOD AND APPARATUS FOR READING OPTICAL INDICIA USING A PLURALITY OF DATA SOURCES filed May 8, 2015 (Smith et al.);
U.S. patent application Ser. No. 14/710,666 for PRE-PAID USAGE SYSTEM FOR ENCODED INFORMATION READING TERMINALS filed May 13, 2015 (Smith);
U.S. patent application Ser. No. 29/526,918 for CHARGING BASE filed May 14, 2015 (Fitch et al.);
U.S. patent application Ser. No. 14/715,672 for AUGUMENTED REALITY ENABLED HAZARD DISPLAY filed May 19, 2015 (Venkatesha et al.);
U.S. patent application Ser. No. 14/715,916 for EVALUATING IMAGE VALUES filed May 19, 2015 (Ackley);
U.S. patent application Ser. No. 14/722,608 for INTERACTIVE USER INTERFACE FOR CAPTURING A DOCUMENT IN AN IMAGE SIGNAL filed May 27, 2015 (Showering et al.);
U.S. patent application Ser. No. 29/528,165 for IN-COUNTER BARCODE SCANNER filed May 27, 2015 (Oberpriller et al.);
U.S. patent application Ser. No. 14/724,134 for ELECTRONIC DEVICE WITH WIRELESS PATH SELECTION CAPABILITY filed May 28, 2015 (Wang et al.);
U.S. patent application Ser. No. 14/724,849 for METHOD OF PROGRAMMING THE DEFAULT CABLE INTERFACE SOFTWARE IN AN INDICIA READING DEVICE filed May 29, 2015 (Barten);
U.S. patent application Ser. No. 14/724,908 for IMAGING APPARATUS HAVING IMAGING ASSEMBLY filed May 29, 2015 (Barber et al.);
U.S. patent application Ser. No. 14/725,352 for APPARATUS AND METHODS FOR MONITORING ONE OR MORE PORTABLE DATA TERMINALS (Caballero et al.);
U.S. patent application Ser. No. 29/528,590 for ELECTRONIC DEVICE filed May 29, 2015 (Fitch et al.);
U.S. patent application Ser. No. 29/528,890 for MOBILE COMPUTER HOUSING filed Jun. 2, 2015 (Fitch et al.);
U.S. patent application Ser. No. 14/728,397 for DEVICE MANAGEMENT USING VIRTUAL INTERFACES CROSS-REFERENCE TO RELATED APPLICATIONS filed Jun. 2, 2015 (Caballero);
U.S. patent application Ser. No. 14/732,870 for DATA COLLECTION MODULE AND SYSTEM filed Jun. 8, 2015 (Powilleit);
U.S. patent application Ser. No. 29/529,441 for INDICIA READING DEVICE filed Jun. 8, 2015 (Zhou et al.);
U.S. patent application Ser. No. 14/735,717 for INDICIA-READING SYSTEMS HAVING AN INTERFACE WITH A USER'S NERVOUS SYSTEM filed Jun. 10, 2015 (Todeschini);
U.S. patent application Ser. No. 14/738,038 for METHOD OF AND SYSTEM FOR DETECTING OBJECT WEIGHING INTERFERENCES filed Jun. 12, 2015 (Amundsen et al.);
U.S. patent application Ser. No. 14/740,320 for TACTILE SWITCH FOR A MOBILE ELECTRONIC DEVICE filed Jun. 16, 2015 (Bandringa);
U.S. patent application Ser. No. 14/740,373 for CALIBRATING A VOLUME DIMENSIONER filed Jun. 16, 2015 (Ackley et al.);
U.S. patent application Ser. No. 14/742,818 for INDICIA READING SYSTEM EMPLOYING DIGITAL GAIN CONTROL filed Jun. 18, 2015 (Xian et al.);
U.S. patent application Ser. No. 14/743,257 for WIRELESS MESH POINT PORTABLE DATA TERMINAL filed Jun. 18, 2015 (Wang et al.);
U.S. patent application Ser. No. 29/530,600 for CYCLONE filed Jun. 18, 2015 (Vargo et al);
U.S. patent application Ser. No. 14/744,633 for IMAGING APPARATUS COMPRISING IMAGE SENSOR ARRAY HAVING SHARED GLOBAL SHUTTER CIRCUITRY filed Jun. 19, 2015 (Wang);
U.S. patent application Ser. No. 14/744,836 for CLOUD-BASED SYSTEM FOR READING OF DECODABLE INDICIA filed Jun. 19, 2015 (Todeschini et al.);
U.S. patent application Ser. No. 14/745,006 for SELECTIVE OUTPUT OF DECODED MESSAGE DATA filed Jun. 19, 2015 (Todeschini et al.);
U.S. patent application Ser. No. 14/747,197 for OPTICAL PATTERN PROJECTOR filed Jun. 23, 2015 (Thuries et al.);
U.S. patent application Ser. No. 14/747,490 for DUAL-PROJECTOR THREE-DIMENSIONAL SCANNER filed Jun. 23, 2015 (Jovanovski et al.); and
U.S. patent application Ser. No. 14/748,446 for CORDLESS INDICIA READER WITH A MULTIFUNCTION COIL FOR WIRELESS CHARGING AND EAS DEACTIVATION, filed Jun. 24, 2015 (Xie et al.).

### EXAMPLE EMBODIMENTS

A1. A method for determining an amount of remaining print media in a printer, the method comprising:

receiving a waveform signal from an encoder wheel having a number (n) of sectors and proximate an optical sensor, the waveform signal representing the number of sectors (m) that, during a measurement time (t), pass by the optical sensor as the encoder wheel rotates; and

if the encoder wheel comprises a media encoder wheel, in response to receiving the waveform signal, calculating a length of the remaining print media in a media roll at an instant time t2 (Media_{length2});

if the encoder wheel comprises a ribbon encoder wheel, in response to receiving the waveform signal, one of the following:

calculating a length of the remaining ribbon in a ribbon roll at the instant time t2 (Ribbon_{length2}), the length of the remaining ribbon at the instant time t2 comprising the length of the remaining print media at the instant time t2; and

extrapolating the length of the remaining print media from a plurality of data points defining an interpolation equation.

A2. The method according to claim A1, wherein if the remaining print media comprises non-continuous print media, the method further comprises:

measuring an individual print medium length; and

calculating a quantity of individual print medium printable from the length of the remaining print media by dividing the length of the remaining print media (Media_{length}) by the individual print medium length.

A3. The method according to claim A1, wherein calculating the length of the remaining print media at the instant time t2 (Media_{length2}) comprises:

calculating a difference between an outer diameter of the media roll at an instant time t1 (d1) and the outer diameter of the media roll at the instant time t2 (d2);

determining a number of rotations of the media encoder wheel (Rot_{nbr}), during a time interval from t1 to t2; and

calculating a print media thickness (Th) from the equation:

$$media thickness ( Th ) = \frac{d 1 - d 2}{2 \times {Rot}_{nbr}} ;$$

and

using the following equation:

$${Media}_{lenght} = \frac{π}{4 Th} [ d {1}^{2} - {di}^{2} ]$$

wherein di comprises the outer diameter of a media core of the media roll.

A4. The method according to claim A3, wherein, prior to calculating the difference between the outer diameter of the media roll at the instant time t1 (d1) and the outer diameter of the media roll at the instant time t2 (d2), the method further comprises calculating the outer diameter (d) of the media roll at the instant time t1 (d1) and at the instant time t2 (d2) from one of the following:

(a) a number of stepper motor steps (i) in a single full revolution of the media encoder wheel using the following equation: outer diameter (d)=i/(dots per inch(DPI)×3.1416); and

(b) an angular speed (ω) and a linear speed (ν) of the media encoder wheel using the following equation:

$$Media diameter \text{:} d ( mm ) = 2 ( 25.4 \frac{v}{ω} ) = 2 ( 25.4 \frac{v \cdot ( n \cdot t )}{2 π \cdot m} )$$

wherein the linear speed comprises a print speed and the angular speed (ω) of the media encoder wheel is calculated at an instant time tx using the following equation:

$$Angular speed ( ω ) = \frac{Angle traveled}{Time taken} = \frac{θ}{t}$$

$$ω ( \frac{rad}{s} ) = \frac{θ}{t} = \frac{2 π}{n} \times \frac{m}{t} \{ \begin{matrix}n number of sectors in encoder wheel \\ with \text{:} m number of sectors seen in “ t ” time \\ t = measurement time\end{matrix}$$

A5. The method according to claim A3, further comprising measuring, at depletion of the media roll, the outer diameter (di) of the media core therein to obtain an updated value of di and updating the remaining print media length calculation with the updated value.

A6. The method according to claim A1, wherein calculating the length of the remaining ribbon at the instant time t2 (Ribbon_{length}) comprises:

calculating a difference in an outer diameter of the ribbon roll at an instant time t1 and the outer diameter of the ribbon roll at the instant time t2;

determining a number of rotations (Rot_{nbr}) of the ribbon encoder wheel during a time interval from t1 to t2; and

calculating a ribbon thickness (Th) from the equation:

$$ribbon hickness ( Th ) = \frac{d 1 - d 2}{2 \times {Rot}_{nbr}} ;$$

and

using the following equation:

$${Ribbon}_{length} = \frac{π}{4 Th} [ d {1}^{2} - {di}^{2} ] ,$$

wherein di comprises an outer diameter of a ribbon core of the ribbon roll.

A7. The method according to claim A6, wherein, prior to calculating the difference between the outer diameter of the ribbon roll at the instant time t1 and the outer diameter of the ribbon roll at the instant time t2, the method further comprises calculating the outer diameter (d1) of the ribbon roll at the instant time t1 and the outer diameter (d2) at t2 from one of the following:

(a) a number of stepper motor steps (i) during a single full revolution of the ribbon encoder wheel and using the following equation: Diameter (d)=i/(dots per inch(DPI)×3.1416); and

(b) an angular speed (ω) and a linear speed (ν) of the ribbon encoder wheel and using the following equation:

$$Ribbon diameter \text{:} d ( mm ) = 2 ( 25.4 \frac{v}{ω} ) = 2 ( 25.4 \frac{v \cdot ( n \cdot t )}{2 π \cdot m} )$$

wherein the linear speed comprises a print speed and the angular speed (ω) of the ribbon encoder wheel is calculated at an instant tx using the following equation:

$$Angular speed ( ω ) = \frac{Angle traveled}{Time taken} = \frac{θ}{t}$$

$$ω ( \frac{rad}{s} ) = \frac{θ}{t} = \frac{2 π}{n} \times \frac{m}{t} \{ \begin{matrix}n number of sectors in encoder wheel \\ with \text{:} m number of sectors seen in “ t ” time \\ t measurement time\end{matrix}$$

A8. The method according to claim A6, further comprising measuring, at depletion of the ribbon roll, the outer diameter (di) of the ribbon core therein to obtain an updated value of di and updating the remaining ribbon length calculation with the updated value.

A9. The method according to claim A1, wherein, prior to extrapolating the length of the remaining print media, the method comprises:

obtaining the plurality of data points by:
calculating a difference in an outer diameter of the ribbon roll at a first instant time tn and the outer diameter of the ribbon roll at a second instant time tn (Rd_used);
determining an amount of print media printed (Md_used) during a time interval from the first instant time tn to the second instant time tn;
repeating the steps at successive time intervals of calculating the difference in the outer diameter of the ribbon roll and determining the amount of print media printed,
wherein each data point comprises the difference in the outer diameter of the ribbon roll and the amount of print media printed (Md_used) during the time interval and during successive time intervals; and
   defining an interpolation equation from the plurality of data points, the interpolation equation defining a relationship between the Md_used per Rd_used:

Md_{usedx}−F(Rd__{^{usedx}}).

B1. A printer comprising:

a supply spindle including an encoder wheel proximate an optical sensor, the encoder wheel configured to output a waveform signal as the encoder wheel rotates; and

a processor communicatively coupled to the encoder wheel and configured to:
receive the waveform signal from the encoder wheel having a number of sectors (n), the waveform signal representing a number of sectors (m) that, during a measurement time (t), pass by the optical sensor as the encoder wheel rotates;
wherein if the encoder wheel comprises a media encoder wheel, calculate a length of remaining print media in a media roll at instant t2 (Media_{length2}) using the waveform signal;
wherein if the encoder wheel comprises a ribbon encoder wheel and using the waveform signal, one of the following:
calculate a length of the remaining ribbon in a ribbon roll at instant t2 (Ribbon_{length2}), the length of the remaining ribbon at t2 comprising the length of the remaining print media at t2; and
extrapolate the length of the remaining print media from a plurality of data points.

B2. The printer according to claim B1, wherein the printer further comprises a stop sensor, the print media is non-continuous print media, and the amount of print media comprises a print medium quantity and wherein the processor is further configured to receive a print medium length from the stop sensor of the printer and in response thereto, determine the print medium quantity by dividing the length of the remaining media by the print medium length.

B3. The printer according to claim B1, wherein the processor is further configured to:

calculate a difference between an outer diameter of the media roll at an instant time t1 and the outer diameter of the media roll at the instant time t2;

determine a number of rotations of the media encoder wheel (Rot_{nbr}) during a time interval from t1 to t2; and

calculate a print media thickness (Th) from the equation:

$$media thickness ( Th ) = \frac{d 1 - d 2}{2 \times {Rot}_{nbr}} ;$$

and

use the following equation to calculate the length of the remaining print media at the instant time t2 (Media_{length2}):

$${Media}_{Length} = \frac{π}{4 Th} [ d {1}^{2} - {di}^{2} ]$$

wherein di comprises an outer diameter of a media core of the media roll.

B4. The printer according to claim B3, wherein the processor is further configured to:

calculate the outer diameter of the media roll at instant time t1 (d1) and at instant time t2 (d2) from one of the following:
a number of stepper motor steps (i) in a single full revolution of the media encoder wheel using the following equation: Diameter (d)=i/(dots per inch(DPI)×3.1416); and
an angular speed (ω) and a linear speed (ν) of the media encoder wheel using the following equation:

$$Media diameter \text{:} d ( mm ) = 2 ( 25.4 \frac{v}{ω} ) = 2 ( 25.4 \frac{v \cdot ( n \cdot t )}{2 π \cdot m} )$$

wherein the linear speed comprises a print speed and the angular speed (ω) of the media encoder wheel is calculated at an instant tx using the following equation:

$$Angular speed ( ω ) = \frac{Angle traveled}{Time taken} = \frac{θ}{t}$$

$$ω ( \frac{rad}{s} ) = \frac{θ}{t} = \frac{2 π}{n} \times \frac{m}{t} \{ \begin{matrix}n number of sectors in encoder wheel \\ with \text{:} m number of sectors seen in “ t ” time \\ t measurement time\end{matrix}$$

B5. The printer according to claim B3, wherein the processor is further configured to:

calculate a difference in an outer diameter of the ribbon roll at an instant time t1 and at the instant time t2;

determine a number of rotations (Rot_{nbr}) of the ribbon encoder wheel during a time interval from t1 to t2; and

calculate a ribbon thickness (Th) from the equation:

$$ribbon hickness ( Th ) = \frac{d 1 - d 2}{2 \times {Rot}_{nbr}} ;$$

and

use the following equation:

$${Ribbon}_{Length} = \frac{π}{4 Th} [ d {1}^{2} - {di}^{2} ] ,$$

wherein di comprises an outer diameter of a ribbon core of the ribbon roll.

B6. The printer according to claim B3, wherein the processor is further configured to:

obtain the plurality of data points by:
calculating a difference in an outer diameter of the ribbon roll at a first instant time and the outer diameter of the ribbon roll at the second instant time (Rd_used);
determining an amount of print media printed (Md_used) during a time interval between the first instant time and the second instant time;
repeating, at successive time intervals, the steps of calculating the difference in the outer diameter of the ribbon roll and determining the amount of print media printed; and

define an interpolation equation from the plurality of data points, the interpolation equation defining a relationship between the Md_used per Rd_used:

Md_{usedx}=F(Rd__{^{usedx}}).

C1. A printer comprising:

a ribbon supply spindle configured for having a ribbon roll disposed thereon, the ribbon supply spindle including a ribbon encoder wheel proximate an optical sensor, the ribbon supply spindle configured to rotate and output a ribbon waveform signal representing a number of sectors (m) on the ribbon encoder wheel that pass by the optical sensor as the ribbon encoder wheel rotates during operation of the printer;

a motor for rotating the ribbon supply spindle and the ribbon roll disposed thereon;

a thermal print head utilized to thermally transfer a portion of ink from an ink ribbon in the ribbon roll to print media as the ink ribbon is unwound from the ribbon supply spindle; and

a processor communicatively coupled to the ribbon encoder wheel and configured to:
receive the ribbon waveform signal from the ribbon encoder wheel; and
at least one of the following
   extrapolate a length of remaining print media from a plurality of data points; and
   calculate a length of remaining ribbon in the ribbon roll at instant t2 (Ribbon_{length2}) in which case the processor is further configured to:
      calculate a difference in an outer diameter of the ribbon roll at an instant time t1 and at the instant time t2;
      determine a number of rotations (Rot_{nbr}) of the ribbon encoder wheel during a time interval from t1 to t2; and
      calculate a ribbon thickness (Th) from the equation:

$$ribbon hickness ( Th ) = \frac{d 1 - d 2}{2 \times {Rot}_{nbr}} ;$$

and
use the following equation:

$${Ribbon}_{Lenght} = \frac{π}{4 Th} [ d {1}^{2} - d {i}^{2} ] ,$$

wherein di comprises an outer diameter of a ribbon core of the ribbon roll.

C2. The printer according to claim C1, further comprising:

a media supply spindle configured for having a media roll disposed thereon, the media supply spindle including a media encoder wheel proximate an optical sensor and the processor communicatively coupled thereto, the media supply spindle configured to rotate and output a media waveform signal representing a number of sectors (m) on the media encoder wheel that pass by the optical sensor proximate the media encoder wheel as the media encoder wheel rotates during operation of the printer;

a motor for rotating the media supply spindle and the media roll disposed thereon; and

wherein the processor is further configured to:

calculate a difference between an outer diameter of the media roll at t1 and the outer diameter of the media roll at t2;

determine a number of rotations of the media encoder wheel (Rot_{nbr}), during a time interval from t1 to t2;

calculate a print media thickness (Th) using the equation:

$$media thickness ( Th ) = \frac{d 1 - d 2}{2 \times {Rot}_{nbr}} ;$$

and

calculate the length of the remaining print media in the media roll at instant t2 (Media_{length2}) from the difference and from the number of rotations of the media encoder wheel (Rot_{nbr}) using the equation:

$${Media}_{Length} = \frac{π}{4 Th} [ d {1}^{2} - {di}^{2} ]$$

wherein di comprises an outer diameter of a media core of the media roll.

C3. The printer according to claim C1, wherein the printer further comprises a stop sensor, the print media is non-continuous print media, and the amount of print media comprises a print medium quantity and wherein the processor is further configured to receive a print medium length from the stop sensor of the printer and in response thereto, determine the print medium quantity by dividing the remaining print media length by the print medium length.

C4. The printer according to claim C2, wherein the processor is further configured to calculate the outer diameter of the media roll at an instant time by one of the following:
a number of stepper motor steps (i) in a single full revolution of the media encoder wheel using the following equation: Diameter (d)=i/(dots per inch(DPI)×3.1416); and
an angular speed (ω) and a linear speed (ν) of the media encoder wheel using the following equation:

$$Media diameter \text{:} d ( mm ) = 2 ( 25.4 \frac{v}{ω} ) = 2 ( 25.4 \frac{v \cdot ( n \cdot t )}{2 π \cdot m} )$$

wherein the linear speed comprises a print speed and the angular speed (ω) of the media encoder wheel is calculated at an instant tx using the following equation:

$$Angular speed ( ω ) = \frac{Angle traveled}{Time taken} = \frac{θ}{t}$$

$$ω ( \frac{rad}{s} ) = \frac{θ}{t} = \frac{2 π}{n} \times \frac{m}{t} \{ with \text{:} \begin{matrix}\begin{matrix}n number of sectors in encoder wheel \\ m number of sectors seen in {}_{}^{``}{t}{}_{}^{″} time\end{matrix} \\ t measurement time\end{matrix}$$

C5. The printer according to claim C1, wherein the processor is configured, prior to extrapolating the length of the remaining print media, to:

obtain the plurality of data points by:
calculating the difference in the outer diameter of the ribbon roll (Rd_used) at an instant time t1 and at an instant time t2;
determining the amount of print media printed (Md_used) during the same time interval; and
repeating the steps of calculating the difference in the outer diameter of the ribbon roll and determining the amount of print media printed at successive time intervals; and

define an interpolation equation from the plurality of data points, the interpolation equation defining a relationship between the Md_used per Rd_used:

Md_{usedx}=F(Rd_{usedx}).

In the specification and/or figures, typical embodiments of the present invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A method for determining an amount of remaining print media in a printer, the method comprising:
receiving a waveform signal from a media encoder wheel having a number (n) of sectors and proximate an optical sensor, the waveform signal representing the number of sectors (m) that, during a measurement time (t), pass by the optical sensor as the encoder wheel rotates; and
in response to receiving the waveform signal, calculating a length of the remaining print media in a media roll at an instant time t2 (Media_{length2}).

2. The method according to claim 1, wherein if the remaining print media comprises non-continuous print media, the method further comprises:
receiving a signal representative of an individual print medium length; and
calculating a quantity of individual print medium printable from the length of the remaining print media by dividing the length of the remaining print media (Media_{length}) by the individual print medium length.

3. The method according to claim 1, wherein calculating the length of the remaining print media at the instant time t2 (Media_{length2}) comprises:
calculating a difference between an outer diameter of the media roll at an instant time t1 (d1) and the outer diameter of the media roll at the instant time t2 (d2);
determining a number of rotations of the media encoder wheel (Rot_{nbr}) during a time interval from t1 to t2; and
calculating a print media thickness (Th) from the equation:
$$media thickness ( Th ) = \frac{d 1 - d 2}{2 \times {Rot}_{nbr}} ;$$
and
using the following equation:
$${Media}_{Lenght} = \frac{π}{4 Th} [ d {1}^{2} - {di}^{2} ]$$
wherein di comprises the outer diameter of a media core of the media roll.

4. The method according to claim 3, wherein, prior to calculating the difference between the outer diameter of the media roll at the instant time t1 (d1) and the outer diameter of the media roll at the instant time t2 (d2), the method further comprises calculating the outer diameter (d) of the media roll at the instant time t1 (d1) and at the instant time t2 (d2) from an angular speed (ω) and a linear speed (ν) of the media encoder wheel using the following equation:
$$Media diameter \text{:} d ( mm ) = 2 ( 25.4 \frac{v}{ω} ) = 2 ( 25.4 \frac{v \cdot ( n \cdot t )}{2 π \cdot m} )$$
wherein the linear speed comprises a print speed and the angular speed (ω) of the media encoder wheel is calculated at an instant time tx using the following equation:
$$Angular speed ( ω ) = \frac{Angle traveled}{Time taken} = \frac{θ}{t}$$
$$ω ( \frac{rad}{s} ) = \frac{θ}{t} = \frac{2 π}{n} \times \frac{m}{t} \{ with \text{:} \begin{matrix}\begin{matrix}n number of sectors in encoder wheel \\ m number of sectors seen in {}_{}^{``}{t}{}_{}^{″} time\end{matrix} \\ t = measurement time\end{matrix}$$

5. The method according to claim 3, wherein, prior to calculating the difference between the outer diameter of the media roll at the instant time t1 (d1) and the outer diameter of the media roll at the instant time t2 (d2), the method further comprises calculating the outer diameter (d) of the media roll at the instant time t1 (d1) and at the instant time t2 (d2) from a number of stepper motor steps (i) in a single full revolution of the media encoder wheel using the following equation: outer diameter (d)=i/(dots per inch(DPI)×3.1416).

6. The method according to claim 3, further comprising measuring, at depletion of the media roll, the outer diameter (di) of the media core therein to obtain an updated value of di and updating the remaining print media length calculation with the updated value.

7. The method according to claim 1, wherein determining an amount of remaining print media comprises determining a determinative amount of remaining print media.

8. The method according to claim 2, further comprising generating an alert if the length of the remaining print media, the quantity of individual print media, or a combination thereof, is below a minimum threshold amount.

9. A method for determining an amount of remaining print media in a printer, the method comprising:
receiving a waveform signal from a ribbon encoder wheel having a number (n) of sectors and proximate an optical sensor, the waveform signal representing the number of sectors (m) that, during a measurement time (t), pass by the optical sensor as the ribbon encoder wheel rotates; and
in response to receiving the waveform signal, calculating a length of the remaining ribbon in a ribbon roll at the instant time t2 (Ribbon_{length2}), the length of the remaining ribbon at the instant time t2 comprising a length of the remaining print media at the instant time t2.

10. The method according to claim 9, wherein if the remaining print media comprises non-continuous print media, the method further comprises:
receiving a signal representative of an individual print medium length; and
calculating a quantity of individual print medium printable from the length of the remaining print media by dividing the length of the remaining print media (Media_{length}) by the individual print medium length.

11. The method according to claim 9, wherein calculating the length of the remaining ribbon at the instant time t2 (Ribbon_{length}) comprises:
calculating a difference in an outer diameter of the ribbon roll at an instant time t1 and the outer diameter of the ribbon roll at the instant time t2;
determining a number of rotations (Rot_{nbr}) of the ribbon encoder wheel during a time interval from t1 to t2; and
calculating a ribbon thickness (Th) from the equation:
$$ribbon thickness ( Th ) = \frac{d 1 - d 2}{2 \times {Rot}_{nbr}} ;$$
and
using the following equation:
$${Ribbon}_{Lenght} = \frac{π}{4 Th} [ d {1}^{2} - {di}^{2} ] ,$$
wherein di comprises an outer diameter of a ribbon core of the ribbon roll.

12. The method according to claim 11, wherein, prior to calculating the difference between the outer diameter of the ribbon roll at the instant time t1 and the outer diameter of the ribbon roll at the instant time t2, the method further comprises calculating the outer diameter (d1) of the ribbon roll at the instant time t1 and the outer diameter (d2) at t2 from an angular speed (ω) and a linear speed (ν) of the ribbon encoder wheel and using the following equation:
$$Ribbon diameter \text{:} d ( mm ) = 2 ( 25.4 \frac{v}{ω} ) = 2 ( 25.4 \frac{v \cdot ( n \cdot t )}{2 π \cdot m} )$$
wherein the linear speed comprises a print speed and the angular speed (ω) of the ribbon encoder wheel is calculated at an instant tx using the following equation:
$$Angular speed ( ω ) = \frac{Angle traveled}{Time taken} = \frac{θ}{t}$$
$$ω ( \frac{rad}{s} ) = \frac{θ}{t} = \frac{2 π}{n} \times \frac{m}{t} \{ with \text{:} \begin{matrix}\begin{matrix}n number of sectors in encoder wheel \\ m number of sectors seen in {}_{}^{``}{t}{}_{}^{″} time\end{matrix} \\ t measurement time\end{matrix}$$

13. The method according to claim 11, wherein, prior to calculating the difference between the outer diameter of the ribbon roll at the instant time t1 and the outer diameter of the ribbon roll at the instant time t2, the method further comprises calculating the outer diameter (d1) of the ribbon roll at the instant time t1 and the outer diameter (d2) at t2 from a number of stepper motor steps (i) during a single full revolution of the ribbon encoder wheel and using the following equation: Diameter (d)=i/(dots per inch(DPI)×3.1416).

14. The method according to claim 11, further comprising measuring, at depletion of the ribbon roll, the outer diameter (di) of the ribbon core therein to obtain an updated value of di and updating the remaining ribbon length calculation with the updated value.

15. The method according to claim 9, wherein determining an amount of remaining print media comprises determining a determinative amount of remaining print media.

16. The method according to claim 10, further comprising generating an alert if the length of the remaining ribbon, the length of the remaining print media, the quantity of individual print media, an amount of print media printable therefrom, or a combination thereof, is below a minimum threshold amount.

17. A method for determining an amount of remaining print media in a printer, the method comprising:
receiving a waveform signal from a ribbon encoder wheel having a number (n) of sectors and proximate an optical sensor, the waveform signal representing the number of sectors (m) that, during a measurement time (t), pass by the optical sensor as the ribbon encoder wheel rotates; and
in response to receiving the waveform signal, extrapolating the length of the remaining print media from a plurality of data points defining an interpolation equation.

18. The method according to claim 17, wherein, prior to extrapolating the length of the remaining print media, the method comprises:
obtaining the plurality of data points by:
calculating a difference in an outer diameter of the ribbon roll at a first instant time tn and the outer diameter of the ribbon roll at a second instant time tn (Rd_used);
determining an amount of print media printed (Md_used) during a time interval from the first instant time tn to the second instant time tn;
repeating the steps at successive time intervals of calculating the difference in the outer diameter of the ribbon roll and determining the amount of print media printed,
wherein each data point comprises the difference in the outer diameter of the ribbon roll and the amount of print media printed (Md_used) during the time interval and during successive time intervals; and
defining an interpolation equation from the plurality of data points, the interpolation equation defining a relationship between the Md_used per Rd_used:
Md_{usedx}=F(Rd__{^{usedx}}).

19. The method according to claim 18, wherein, prior to calculating the difference between the outer diameter of the ribbon roll at the instant time t1 and the outer diameter of the ribbon roll at the instant time t2, the method further comprises calculating the outer diameter (d1) of the ribbon roll at the instant time t1 and the outer diameter (d2) at t2 from one of the following:
(a) a number of stepper motor steps (i) during a single full revolution of the ribbon encoder wheel and using the following equation: Diameter (d)=i/(dots per inch(DPI)×3.1416); and
(b) an angular speed (ω) and a linear speed (ν) of the ribbon encoder wheel and using the following equation:
$$Ribbon diameter \text{:} d ( mm ) = 2 ( 25.4 \frac{v}{ω} ) = 2 ( 25.4 \frac{v \cdot ( n \cdot t )}{2 π \cdot m} )$$
wherein the linear speed comprises a print speed and the angular speed (ω) of the ribbon encoder wheel is calculated at an instant tx using the following equation:
$$Angular speed ( ω ) = \frac{Angle traveled}{Time taken} = \frac{θ}{t}$$
$$ω ( \frac{rad}{s} ) = \frac{θ}{t} = \frac{2 π}{n} \times \frac{m}{t} \{ with \text{:} \begin{matrix}\begin{matrix}n number of sectors in encoder wheel \\ m number of sectors seen in {}_{}^{``}{t}{}_{}^{″} time\end{matrix} \\ t measurement time\end{matrix}$$

20. The method according to claim 17, wherein if the remaining print media comprises non-continuous print media, the method further comprises:
receiving an individual print medium length; and
calculating a quantity of individual print medium printable from the length of the remaining print media by dividing the length of the remaining print media (Media_{length}) by the individual print medium length.
